(19) United States
(12) Patent Application Publication
(10) Pub. No.: US 2015/0192658 A1
(43) Pub. Date: Jul. 9, 2015

(54) SYSTEMS AND METHODS FOR MOBILE DEVICE MICROLOCATION

(71) Applicant: OmniTrail Technologies, New York, NY (US)

(72) Inventors: Shah ULLAH, San Francisco, CA (US); Niaz Ferdaus KHAN, San Mateo, CA (US); Richard FULLER, Morgan Hill, CA (US); Javed AMAN, San Mateo, CA (US)

(73) Assignee: OmniTrail Technologies

(21) Appl. No.: 14/591,296

(22) Filed: Jan. 7, 2015

Related U.S. Application Data
(60) Provisional application No. 61/924,545, filed on Jan. 7, 2014.

(51) Int. Cl. G01S 5/04

(52) U.S. Cl. CPC G01S 5/04

(57) ABSTRACT

Systems and methods are provided for enabling mobile device detection that is secure, private, and accurate. In an exemplary embodiment, a method is provided for detecting the location of a mobile device. The method comprises receiving at least one packet from a detection device, each packet comprising an identifier of the detection device and a signal strength measurement associated with the mobile device. The method further comprises determining a first vector based on the received at least one packet, retrieving one or more second vectors each comprising one or more signal strengths, and calculating one or more differences between the first vector and the one or more second vectors. Based on the calculated differences, a location of the mobile device is determined and information related to the location of the mobile device is sent to at least one of the mobile device or another device.

### CROSS-REFERENCE TO RELATED APPLICATIONS

This application claims the benefit of U.S. Provisional Patent Application No. 61/924,545, filed on Jan. 7, 2014, and entitled “PASSIVE RADIO FREQUENCY NETWORK TO NETWORK HANDOFF,” the disclosure of which is hereby incorporated by reference in this application.

### BACKGROUND

Many entities are interested in detecting the position of mobile devices such as smart phones, personal media devices, PDAs, or tablets. Many attempt to provide timely information to consumers holding mobile devices by detecting where those devices are. For example, if a consumer is utilizing a Global Positioning System (GPS) navigation system to locate a hotel, an advertiser may provide an advertisement or coupon for a restaurant near the hotel.

Many systems are currently in use for location determination of mobile devices. For example, systems and technologies such as Bluetooth, Bluetooth Low Energy (BLE), Near Field Communication (NFC), Global Positioning System (GPS), and Assisted GPS (a-GPS) have been used to identify the location of a mobile device. Each of these systems, however, suffers from one or more serious problems. For example, because of the relatively short range associated with the technology, Bluetooth-based solutions suffer from a need to have many transponders in even a small enclosed space. This adds unnecessary cost to a system that is supposed to generate more revenue for merchants and other parties. NFC is of a similarly short range and typically requires the user to push a mobile device against an NFC tag or come within a few centimeters of the tag. This requires such effort and close contact that few users are unlikely to willingly press their device against such a tag. Other systems, like GPS and a-GPS, trade the need for proximity to transponders or tags for a sharp increase in battery usage. Using GPS functionality constantly running can decimate the charge on a user's mobile device. This loss in battery power is even more pronounced when the mobile device is inside of a building such as a mall or similar structure. Moreover, because of the need for line-of-sight in GPS-based systems, it may be difficult or impossible to accurately detect the position of a mobile device inside most buildings.

Moreover, while systems exist for locating mobile devices, many of these systems rely on static identifiers for each mobile device. For example, Bluetooth devices utilize MAC (Media Access Control) addresses to identify themselves to other Bluetooth devices. A nefarious actor could utilize information detected by multiple separate entities (such as two or more merchants) to determine when a particular mobile device—and thus the user holding the device—is in a particular location. Once the actor detects where the user is, the actor could take any of a number of actions (for example, breaking into the user's house, robbing the user, or stalking the user from place to place). Thus, typical location detection systems are less than ideal for those with privacy concerns.

The disclosed embodiments solve the above problems as well as many others.

### SUMMARY

Systems and methods are provided for enabling mobile device detection that is secure, private, and accurate. An example method is provided for detecting the location of a mobile device. The method comprises receiving at least one packet from a detection device, each packet comprising an identifier of the detection device and a signal strength measurement associated with the mobile device. The method further comprises determining a first vector based on the received at least one packet, retrieving one or more second vectors each comprising one or more signal strength measurements, and calculating one or more differences between the first vector and the one or more second vectors. The method further comprises, based on the calculated differences, determining a location of the mobile device and sending information related to the location of the mobile device to at least one of the mobile device or another device.

Systems are also provided. An exemplary system comprises a storage device comprising instructions and one or more electronic processors. The one or more electronic processors may be configured to execute the instructions to perform the above exemplary method.

Another exemplary system comprises a detection device, a server, and a mobile device. The mobile device comprises at least one radio configured to transmit wireless beacons for receipt by the one or more detection devices. The detection device comprises a storage device comprising instructions and one or more electronic processors. The one or more electronic processors may be configured to perform a first method comprising receiving one or more beacons from the mobile device, determining a signal strength associated with each beacon, and sending at least one packet comprising at least one beacon and a signal strength to the server. The server comprises a storage device comprising instructions and one or more electronic processors. The one or more electronic processors may be configured to perform a second method comprising receiving at least one packet from the detection device, each packet comprising an identifier of the detection device and a signal strength measurement associated with the mobile device. The second method further comprises determining a first vector based on the received at least one packet, retrieving one or more second vectors comprising one or more signal strengths, and calculating one or more differences between the first vector and the one or more second vectors. The second method further comprises, based on the calculated differences, determining a location of the mobile device and sending information related to the location of the mobile device to at least one of the mobile device or another device.

### BRIEF DESCRIPTION OF DRAWING(S)

FIG. 1 illustrates an exemplary network with information flows between devices in the network, consistent with disclosed embodiments.

FIG. 2A illustrates an exemplary network and processes that occur when a mobile device enters the detection radius of a detection device, consistent with disclosed embodiments.

FIG. 2B illustrates an exemplary network indicating processes that occur when a mobile device leaves the detection radius of a detection device, consistent with disclosed embodiments.

FIG. 3A illustrates an exemplary network indicating processes for detecting the location of a mobile device, consistent with disclosed embodiments.

FIG. 3B illustrates an exemplary tree for storing signatures, consistent with disclosed embodiments.

FIG. 4 illustrates exemplary processes for generating Device Specific Identifiers (DSIs), consistent with disclosed embodiments.

FIG. 5A illustrates an exemplary information flow between a mobile device, an application provider, and an RDS server, for generating identifiers and installing applications, consistent with disclosed embodiments.

FIG. 5B illustrates an exemplary information flow between a mobile device, a detection device, a notification generation system, an RDS server, and other devices, for utilizing an application specific user hash (ASUH), consistent with disclosed embodiments.

FIG. 5C illustrates an exemplary information flow between a mobile device, a detection device, an RDS server, and a mobile provider, for provisioning wireless access using detection device 203, consistent with disclosed embodiments.

FIG. 5D illustrates an exemplary information flow between two application providers and an RDS server, for sharing of user-specific data between applications, consistent with disclosed embodiments.

FIG. 6A illustrates an exemplary process for generating an application ID for use by an application provider and an RDS server, consistent with disclosed embodiments.

FIG. 6B illustrates an exemplary process for approving an application for use with disclosed systems, consistent with disclosed embodiments.

FIG. 6C illustrates an exemplary process for detection device installation and registration of a physical space, consistent with disclosed embodiments.

FIG. 6D illustrates an exemplary process for defining a map for a physical site and enabling application access, consistent with disclosed embodiments.

FIG. 6E illustrates an exemplary training process, consistent with disclosed embodiments.

FIG. 7A illustrates an exemplary user interface for enabling and disabling RDS access on an RDS-enabled mobile device, consistent with disclosed embodiments.

FIG. 7B illustrates an exemplary user interface for enabling and disabling RDS access to particular applications on an RDS-enabled mobile device, consistent with disclosed embodiments.

FIG. 8A illustrates an exemplary process consistent with disclosed embodiments.

FIG. 9A illustrates an exemplary process for transmitting data between a wearable device and a detection device, consistent with disclosed embodiments.

Where possible, the same element reference number is used in different figures to indicate corresponding elements.

### DETAILED DESCRIPTION

Embodiments of the disclosure relate to systems and methods that enable mobile devices to install applications that include identifiers. The identifiers may be used to uniquely identify a particular instance of that application on that particular mobile device. In some embodiments, only the provider of that application can detect the location of the mobile device using the identifier. When a mobile device is detected within a certain distance of one or more detection devices (e.g., access points), a detection device may transmit information received from the mobile device to application provider to perform an action on the mobile device. Embodiments also relate to enabling application providers to share user-specific data with one another, and to enabling a single mobile device to receive information related to its location from multiple application providers. Embodiments also relate to providing wireless network access to mobile devices. Embodiments also relate to detecting the location of a mobile device using known signal signatures emitted from the mobile device.

Embodiments of the present disclosure may be utilized to provide data related to mobile device location. For example, using embodiments of the present disclosure, parties such as merchants, wireless carriers, advertisers, or the like, may provide information on how long users of mobile devices (such as a cell phone) spend in front of particular items in a store. Merchants or other parties can also receive information on particular mobile devices that have entered a location. For example, a floor manager may receive a communication on her mobile device when a frequent customer enters a store, and suggests that the manager approach the customer to greet him. As another example, manufacturers may use this information to determine how best to market their goods—for example, noting which packages draw the attention of in-store consumers, determining which products cause consumers to spend the most time thinking about the purchase, or which products tend to be selected during the same shopping trip.

Embodiments are also usable to provide information to mobile devices upon entering into a particular location. For example, using embodiments of the present disclosure, merchants may provide a message such as “Welcome to our store! Since this is your first time here, please accept this 20% off coupon with our gratitude. This coupon will expire upon leaving the store today or within three hours, whichever comes first” to a mobile device upon determining that the mobile device has entered a location associated with the merchant.

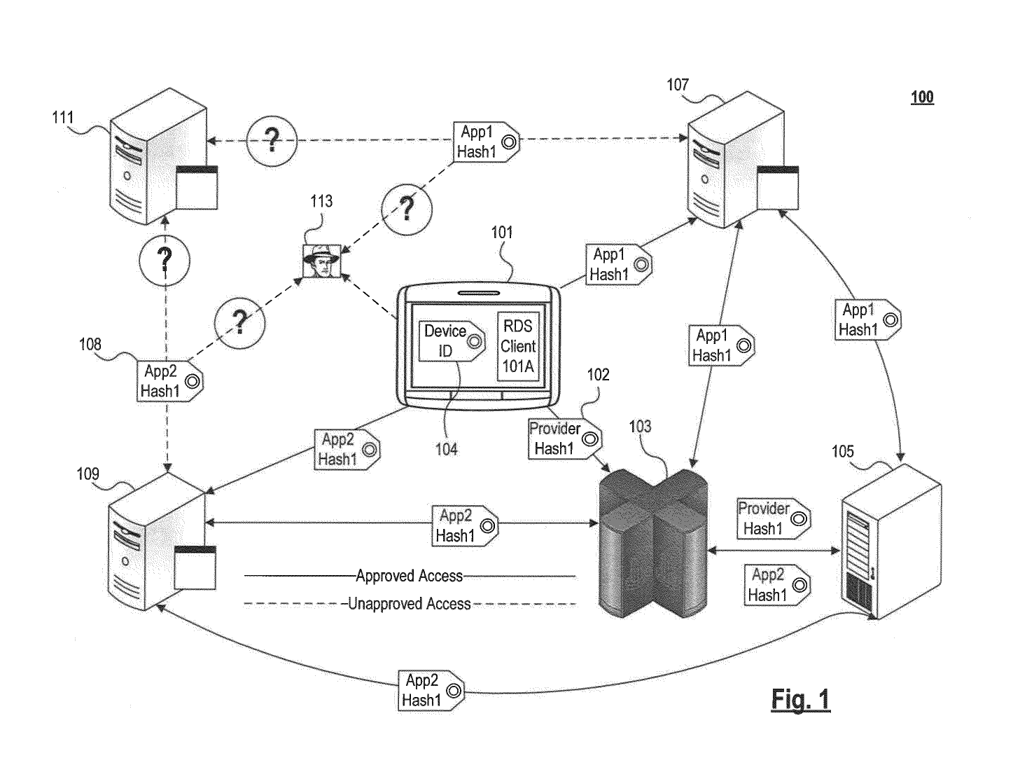

FIG. 1 illustrates an exemplary network 100 with information flows between devices in the network, consistent with disclosed embodiments. Exemplary network diagram 100 includes mobile device 101, provider server(s) 103, RDS server 105, application providers 107 and 109, unauthorized provider 111, and hacker 113.

Mobile device 101 comprises an electronic device such as a smartphone, a cellular phone, a personal media player, a tablet, an asset tracking device, or the like. In some embodiments, mobile device 101 has connectivity using both a wireless carrier network (e.g., cellular) and a wireless packet network (e.g., IEEE 802.11 or “Wi-Fi”). In other embodiments, mobile device 101 is a device that comprises wireless packet network connectivity alone (e.g., a device having Wi-Fi network access) and does not have access to a cellular network. Mobile device 101 may be carried by a user (e.g., a consumer or an employee) or may be affixed to an item (e.g., a computer, machinery, merchandise, or other equipment). Mobile device 101 may comprise RDS client 101A. RDS client 101A, which may be implemented in software, hardware, firmware, or a combination thereof, may be configured to enable communications between mobile device 101 and other devices (such as provider server(s) 103, RDS server 105, or application providers 107 and 109).

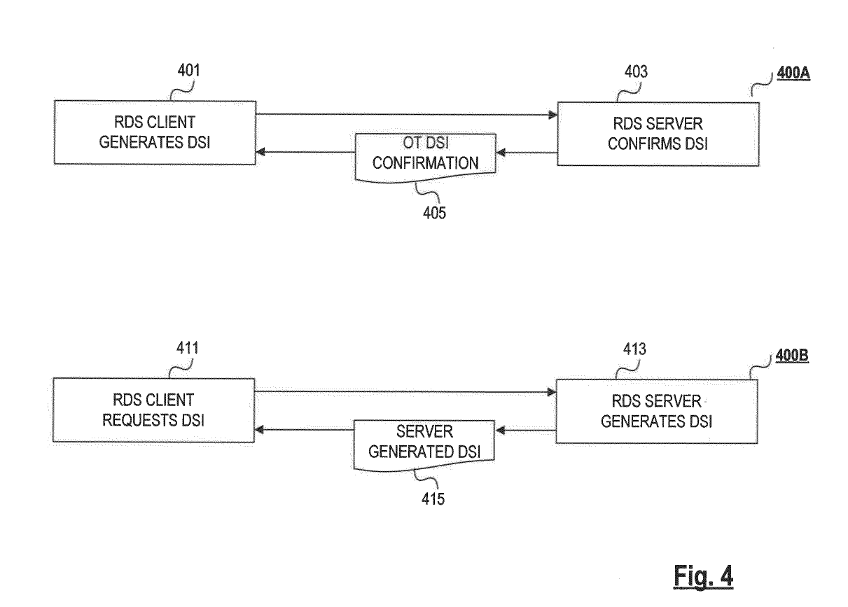

Mobile device 101 comprises a device identifier (DSI) 104. For example, DSI 104 may be based on an identifier that uniquely identifies mobile device 101, such as an IMEI (International Mobile station Equipment Identity) or a MAC (Media Access Control) address. (An exemplary method for generating DSI 104 is explained below with reference to FIG. 4.) Mobile device 101 may be configured to emit data at specified intervals. The data (also referred to herein as a “beacon”) may include DSI 104 as well as other information. In some embodiments, the beacons may be constructed such that access points not specially configured to receive the beacons may determine that the beacons are malformed communications and discard them.

Provider server(s) 103 comprise one or more devices that provide network service to mobile device 101. For example, if mobile device 101 is a cellular phone or smartphone that uses a cellular network for communication, provider server(s) 103 may be a cellular network operator. Provider servers) 103 may have one or more associated hashes 102. In some embodiments, for example, where mobile device 101 is a cellular phone, a smartphone, or another electronic device that communicates using a cellular or satellite network, provider server(s) 103 may be utilized to provision network access to mobile device 101. In these embodiments, systems such as mobile device 101 and application providers 107 and 109 may communicate with RDS server 105 directly or through provider server(s) 103. In other embodiments, for example, where mobile device 101 is a personal media player, tablet, or another electronic device that does not use a cellular or satellite network, provider server(s) 103 are optional and may be omitted from the system. In these embodiments, systems such as mobile device 101 and application providers 107 and 109 communicate with RDS server 105 directly. In other embodiments, provider server(s) 103 may be configured to provide wireless “hot-spot”access (e.g., a network of wireless access points that a user can access via a subscription and/or a membership).

RDS server 105 comprises one or more devices that provide remote data services to one or more of provider server(s) 103, mobile device 101, or application providers 107 and 109. For example, RDS server 105 may be configured to perform a number of functions by communicating with other devices, such as receiving an indication from a detection device (e.g., an access point) related to the presence or absence of mobile device 101, maintaining a listing of observed mobile devices 101, maintaining a mapping of one or more detection devices in a particular location, maintaining a database of observed signals received from devices in proximity to one or more detection devices in a particular location, generating application identifiers, keys, and application instance user-specific hashes (ASUHs), receiving identifiers (e.g., DSIs 104) from one or more detection devices, sending information to application providers 107 or 109, or the like.

Application providers 107 and 109 comprise devices that provide applications for use by mobile device 101. In some embodiments, application providers 107 and 109 represent two different application developers, each of which operate different applications usable by mobile device 101. Application providers 107 and 109 are associated with application hashes 106 and 108, respectively. Application hashes 106 and 108, in some embodiments, are used to represent a particular installation of an application provided by an application provider. These hashes may be utilized by mobile device 101, RDS server 105, application providers 107 and 109, or other devices, in order to provide for secure data transmission between these devices.

Unauthorized provider 111, in some embodiments, represents one or more devices that provide other applications for use by mobile device 101. For example, unauthorized provider 111 does not possess the necessary information to decrypt or otherwise utilize the information represented by application hashes 106 and 108. As one example, unauthorized provider 111 may be a benign party that creates applications that have not been installed on to mobile device 101. As another example, unauthorized provider 111 may be a party that creates applications but has not yet been approved to provide said applications to mobile device 101 (e.g., by RDS server 105). Similarly, hacker 113 does not possess the necessary information to decrypt or otherwise utilize the information represented by application hashes 106 and 108.

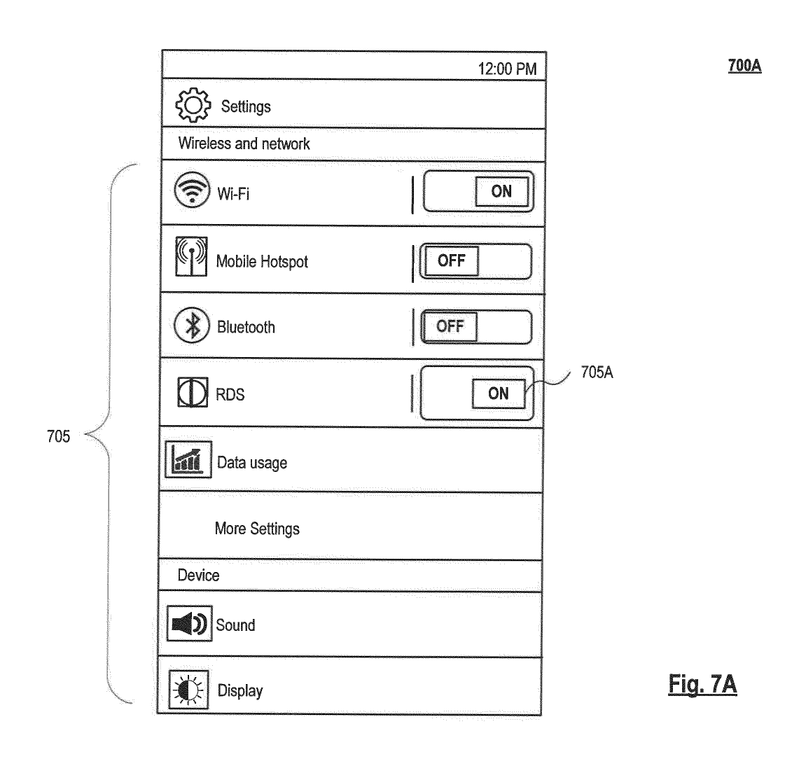

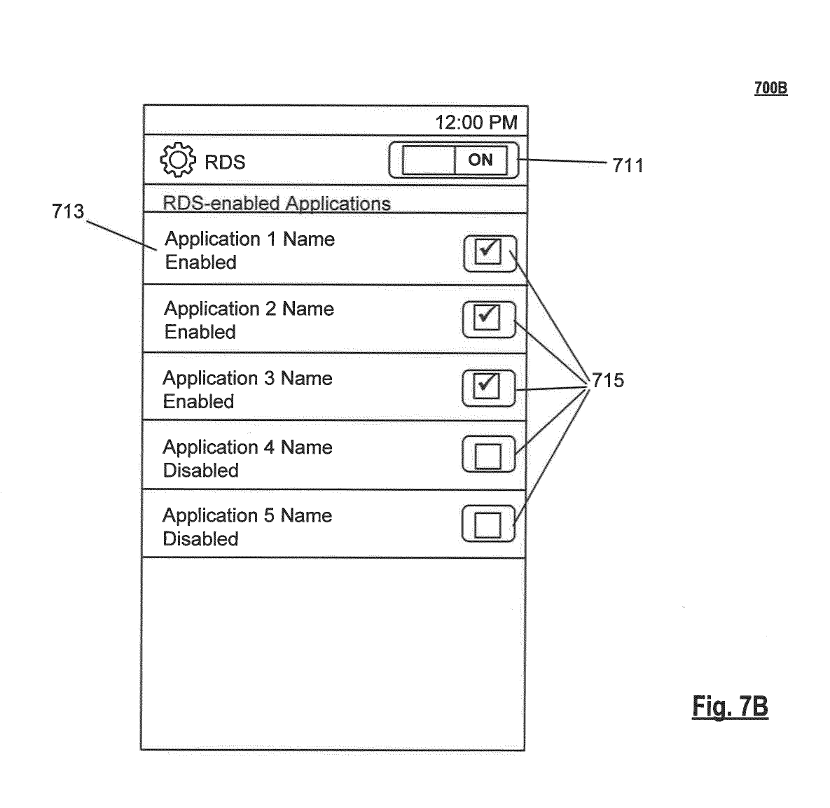

As an example of a process implemented using the devices illustrated in FIG. 1, application provider 107 provides a coupon provisioning system for delivering coupons to mobile device 101 and application provider 109 provides a mobile “check in” service that notifies a user's friends of the user's location. When mobile device 101 enters a particular retail location, application providers 107 and 109 may receive DSI 104. Moreover, if a user of mobile device 101 does not want to notify his friends about his presence at a retail location (e.g., because he is buying surprise gifts for those friends) but still wants to receive coupons for that retail location, the user may temporarily and/or permanently disable application provider 109 from receiving DSI 104 while still allowing application provider 107 to receive DSI 104. (This is explained further below with respect to FIGS. 7A and 7B.)

As another example of a process, provider server(s) 103 may also be configured to provide information related to mobile device 101. For example, in embodiments where mobile device 101 is a smartphone, cellular phone, or other device receiving network service from provider server(s) 103, provider server(s) 103 may receive an application hash associated with mobile device 101 (e.g., hash 108) from an application server (e.g., application server 109). Provider server(s) 103 may send the application hash 108 to RDS server 105. RDS server 105 may determine an application hash associated with mobile device 101 that is also associated with provider server(s) 103 (e.g., provider hash 102), RDS server 105 may send that determined application hash 102 to provider server(s) 103. Provider server(s) 103 may utilize application hash 102 to determine other information about mobile device 101 (for example, age of the user, type of device, demographic information, or the like) and send that information to application provider 109.

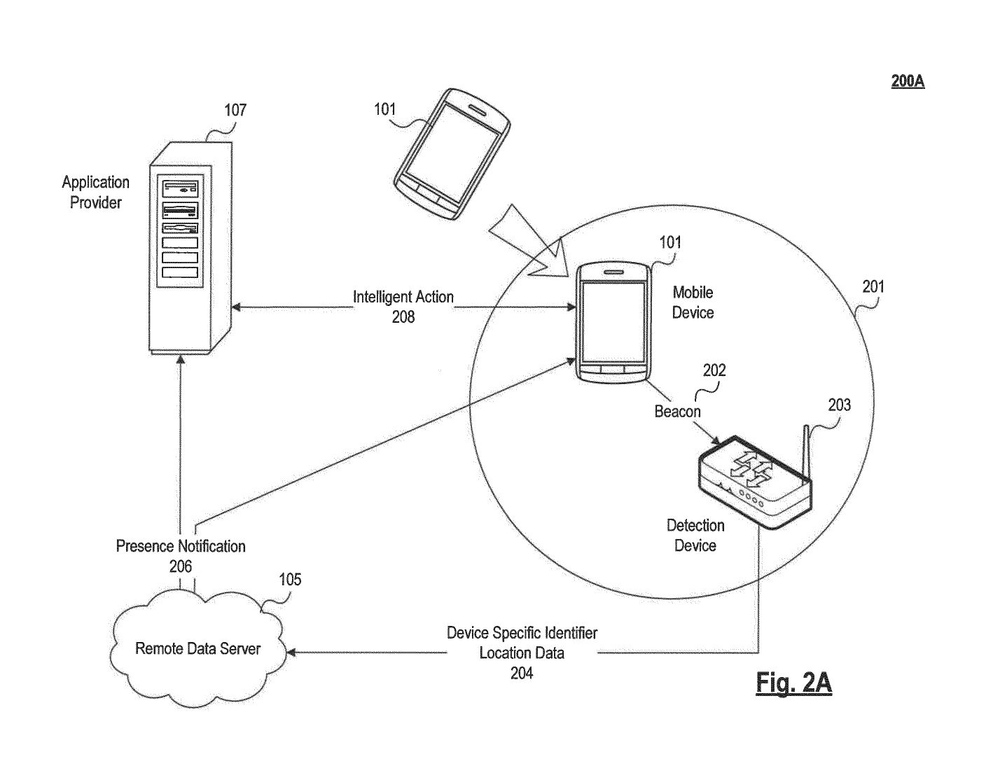

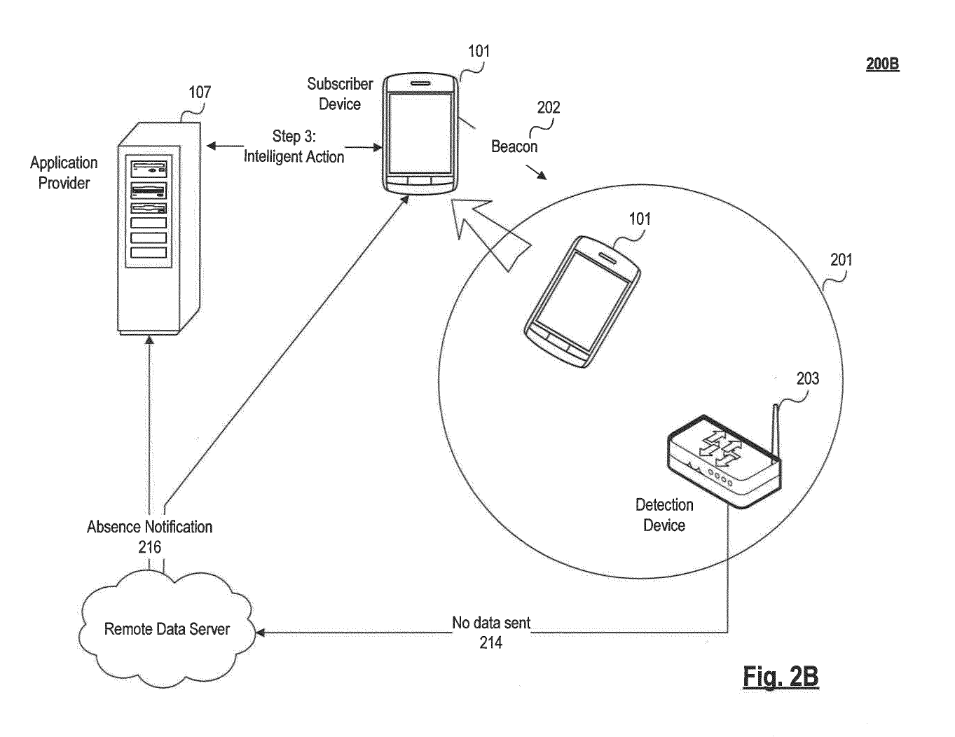

FIG. 2A illustrates an exemplary network 200A and processes that occur when mobile device 101 enters the detection radius 201 of detection device 203, consistent with disclosed embodiments. Mobile device 101 may enter detection radius 201 in a number of ways. For example, a user may carry mobile device 101 into a building (e.g., a store or a department within a store), or an employee may move an item (e.g., machinery or a pallet of items for sale) that contains mobile device 101 into a specified area of a warehouse.

Detection device 203, in some embodiments, may be implemented as a wireless (e.g., Wi-Fi implementation of IEEE 802.11) access point having at least one antenna. Detection radius 201 may comprise a particular area, such as one hundred feet squared (100 ft²) surrounding detection device 203. In some embodiments, a physical location may have more than one detection device 203. A location, moreover, may have overlapping detection radii. (For ease of illustration, however, only a single detection device 203 is shown in exemplary FIG. 2A.)

In some embodiments, mobile device 101 may emit a beacon 202 that includes a Device Specific Identifier (DSI) 104 at specified intervals. For example, mobile device 101 may emit beacon 202 once every 200 milliseconds. Alternatively or in addition, mobile device 101 may emit beacon 202 each time that displacement sensors on mobile device 101 (not pictured) detect that mobile device 101 has moved by a specified amount. For example, a gyroscope on mobile device 101 may be operable to detect that mobile device 101 has moved more than one meter, and may cause mobile device 101 to generate and send beacon 202. As another examiner, mobile device 101 may detect that a user is attempting to make an emergency call (e.g., 911) or send an emergency message, and may cause mobile device 101 to generate and send beacon 202. Mobile device 101 may also be configured to modify the interval at which beacons are sent based on other actions. For example, mobile device 101 may communicate with sensors such as GPS sensors (not pictured) to detect when a user enters a bounded space such as a building. Mobile device 101 may modify the interval based on that determination. For example, if mobile device 101 determines that it has been brought into a bounded space (e.g., indoors), it may increase the interval to once every 100 milliseconds, and if it has been brought outside of a bounded space (e.g., outdoors), it may decrease the interval to once every 900 milliseconds.

Detection device 203 may receive beacon 202 from mobile device 101. In step 204, detection device 203 may send DSI 104 encoded in received beacon 202 to RDS server 105. (For example, detection device 203 may embed the DSI 104 in a packet for sending to RDS server 105.) Step 204 may also comprise sending location data related to detection device 203 (e.g., a latitude/longitude of detection device 203, an identifier associated with detection device 203, an encoded location associated with detection device 203, or any other information to enable RDS server 105 to determine the location of detection device 203).

RDS server 105 receives the communication from detection device 203 and, in step 206, may generate and/or send one or more presence notifications to at least one of application provider 107 or mobile device 101. For example, RDS server 105 may send a presence notification to application provider 107 indicating that mobile device 101 is in a particular location. In step 208, application provider 107 may then take one or more actions. For example, application provider 107 may receive an indication that mobile device 101 is in a particular aisle of a retail store. Application provider 107 may then generate and send a coupon to mobile device for an item that is located in that aisle. Mobile device 101 may receive the coupon and display it for the user, notify the user of its receipt, or otherwise indicate to the user that data has been received.

As another example, RDS server 105 may send a presence notification to mobile device 101 indicating that mobile device 101 is in a particular location and that the user can take certain actions. For example, RDS server 105 may determine that the presence of mobile device 101 in a particular location grants the user holding mobile device 101 access to particular information on a computer terminal (not pictured). RDS server 105 may send a notification to application provider 107 indicating that the user should be granted access to a computer terminal in the vicinity of mobile device 101, and may send a notification to mobile device 101 including a one-time password for use in logging into that computer terminal.

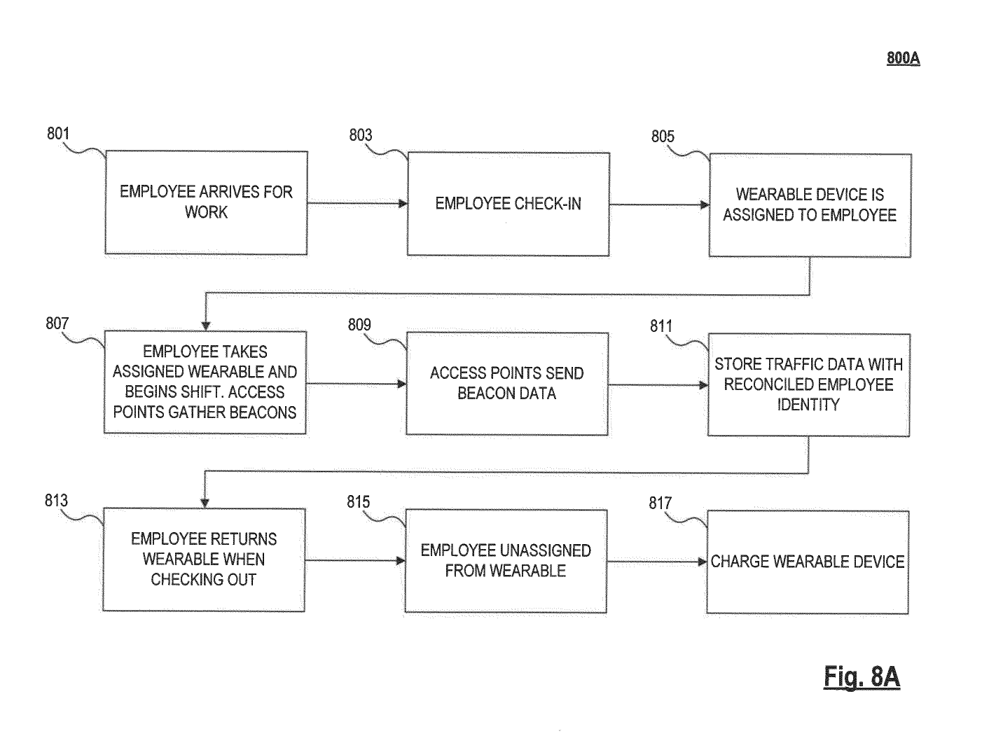

Another example of the embodiments disclosed in FIG. 2A is represented in FIG. 8A, described below.

FIG. 2B illustrates an exemplary network and processes that occur when mobile device 101 leaves detection radius 201 of detection device 203, consistent with disclosed embodiments. For example, detection device 203 may determine that it had previously received three beacons 202 from mobile device 101 at 200-millisecond intervals, but has not received a beacon from mobile device 101 in the past 30 seconds. As another example, detection device 203 may determine that it is receiving beacons at a reduced rate. For example, detection device 203 may determine that it had previously received three beacons 202 from mobile device 101 at 200-millisecond intervals, but has received the last three beacons at 400-millisecond intervals. As another example, detection device 203 may receive a communication from another detection device (not pictured) indicating that mobile device 101 has moved to a different location (e.g., closer to another detection device and out of the range of detection device 203).

In step 214, detection device 203 may send an indication to RDS server 105 that it has not received beacon 202 from mobile device 101. In step 216, RDS server 105 may generate an absence notification related to the indication received in step 214. RDS server 105 may then send the absence notification to one or more of application provider 107 or mobile device 101 in order to enable one or more actions to be taken in step 218.

As one example, RDS server 105 may send the absence notification to application server 107. Application server 107 may generate a coupon for sending to mobile device 101 in an attempt to get the user to re-enter a retail store. For example, application server 107 may generate a coupon that reads “User, are you sure you want to leave without buying a package of paper towels? Here is a special discount for $5.00 off of a single package! Code: 123456” and send it to mobile device 101 to entice the user to go back and purchase that product.

As another example, RDS server 105 may send the absence notification to mobile device 101, requesting a confirmation that the user wishes to log out of a computer terminal (not pictured) in the vicinity of detection device 203. For example, the absence notification may cause mobile device 101 to read “Are you done with your session at Terminal 16? If so, please press the button marked Log Out. If you wish to continue your session, please go back to the terminal and press a key. Otherwise, you will automatically be logged out in ten seconds.” If the user indicates (e.g., on mobile device 101 or the computer terminal) that she wishes to log out, in step 218, mobile device 101 and/or the computer terminal may send a communication to application provider 107 requesting the session should be ended.

Other example uses for the systems depicted in FIGS. 2A and 2B are possible as well—such as in-home automation or energy conservation, security, displaying advertisements on a screen separate from that on mobile device 101 (e.g., an in-store monitor), digital rights management (e.g., enabling a user of mobile device 101 to play a particular media file when in proximity to a particular location), motion detection, or the like.

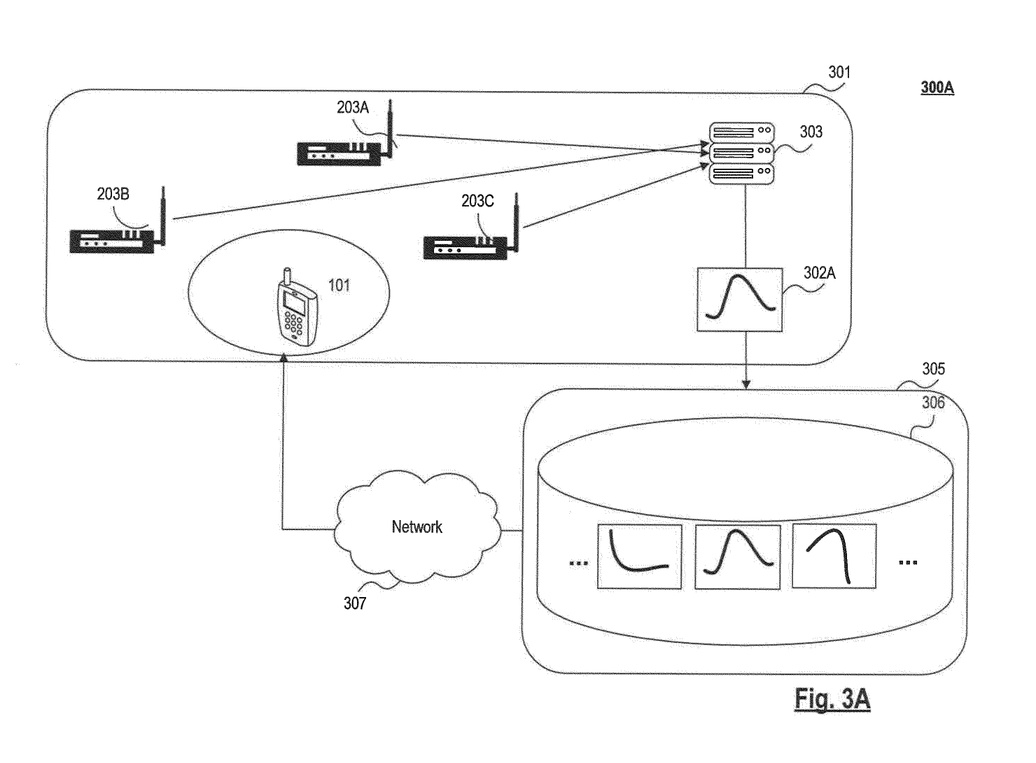

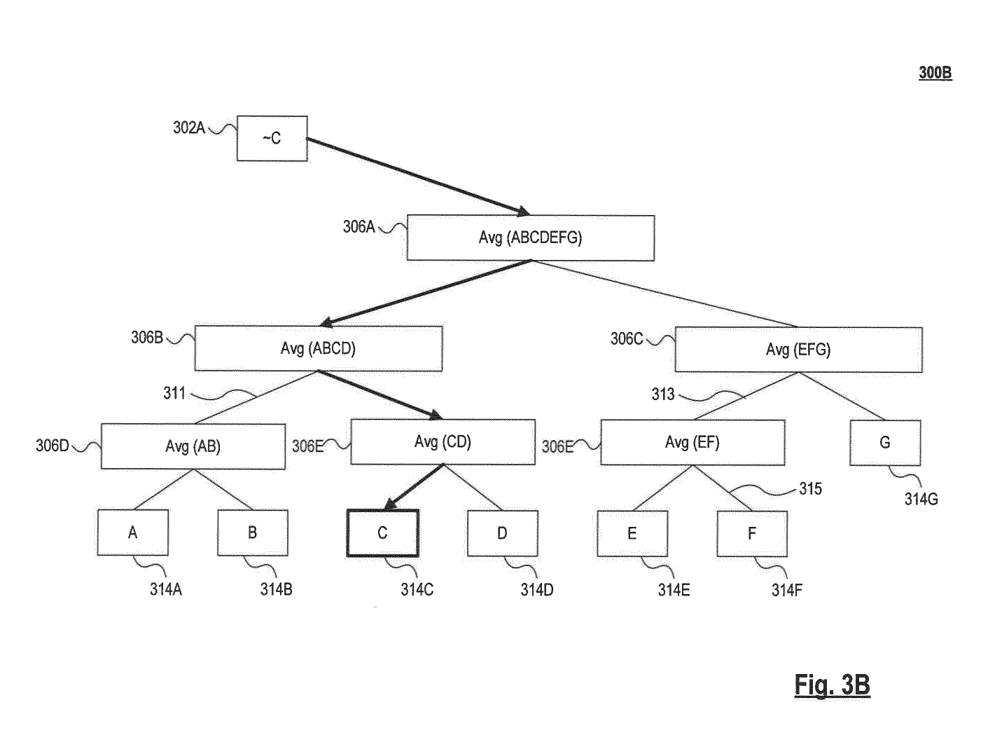

FIG. 3A illustrates an exemplary network 300A indicating processes for detecting the location of a mobile device 101, consistent with disclosed embodiments. Network 300A includes mobile device 101, detection devices 203A, 203B, and 203C, database 306, local server 303, and remote server 305.

As explained above with respect to FIGS. 1, 2A, and 2B, in some embodiments mobile device 101 may be implemented as smartphones, cellular phones, asset tracking devices, or other devices, and detection devices 203A, 203B, and 203C may be implemented as wireless access points. Detection devices 203A, 203B, and 203C may be situated in area 301 (e.g., a particular retail location or a department within that location) and be further configured to detect signatures of beacon 202 received from mobile device 101. In some embodiments, detection devices 203A-203C may be offset from one another both horizontally (e.g., on the same floor of a building) and vertically (e.g., on different floors of a building or at different heights in the building).

When a user enters area 301 with mobile device 101, a line of sight between mobile device 101 and one or more of detection devices 203A, 203B, and 203C may be blocked by one or more interfering items in area 301. Moreover, the distance between mobile device 101 and one or more of detection devices 203A, 203B, and 203C may affect communication between these devices. This may affect how beacon 202 is received by detection devices 203A-203C. For example, if mobile device 101 has an unimpeded line-of-sight to detection device 203A but is in a position where the line-of-sight between it and detection device 203B is attenuated by a support beam, the signals received by each of detection devices 203A and 203B may be received at different times, may reflect different levels of interference, and may have different signal strengths. As one example, if the line-of-sight between mobile device 101 and detection device 203C is impeded by a number of devices that utilize the same frequency (e.g., 2.4 GHz wireless), detection device 203C may receive beacon 202 with a significant amount of additional signals that, with respect to beacon 202, detection device 203C observes as noise. As another example, if mobile device 101 has unimpeded lines-of-sight to detection device 203A and 203B, but device 203B is twice as far as device 203A, the signal strength for communications between mobile device 101 and device 203B may be significantly weaker than the one between mobile device 101 and device 203A.

Local server 303 comprises one or more devices configured to receive one or more signals (e.g., packets) from detection devices 203A-203C indicating how beacon 202 was received by each device. Local server 303 may combine the signals to determine a signature 302A for the beacon. The particular characteristics of a beacon 202 as it is received by one or more of detection devices 203A-203C make up signature 302A. As one example, if the signature is formed using the average of all signals, and beacon 202 was only received by detection devices 203A and 203C, local server 303 may receive signals representing beacon 202 as it was received by devices 203A and 203C, determine the values comprising each signal, add the values of each signal, and divide the added signals by the number of receiving beacons (i.e., two) to generate signature 302A. In other embodiments, local server 303 may combine the signals by adding them together (e.g., point-by-point addition of each signal), multiplying each signal (e.g., point-by-point multiplication of each signal), or the like.

One particular manner of generating the signature includes generating a vector with dimensions equal to the total number of detection devices 203A-203C. The vector may comprise averages of each received signal strength associated with each device. For example, if each detection device received four beacons from mobile device 101 and provides two measurements of each beacon (e.g., using multiple antennae), the signature could be computed as a vector having the average of each measurement from each detection device:

| | DD203A | DD203A | DD203B | DD203B | DD203C | DD203C |
|---|---|---|---|---|---|---|
| | Measure 1 | Measure 2 | Measure 1 | Measure 2 | Measure 1 | Measure 2 |
| Beacon 1 | 3 | 1 | 3 | 1 | 5 | 5 |
| Beacon 2 | 2 | 2 | 2 | 4 | 5 | 4 |
| Beacon 3 | 3 | 2 | 3 | 3 | 4 | 4 |
| Beacon 4 | 2 | 1 | 1 | 2 | 4 | 5 |
| Average | 2.5 | 1.5 | 2.25 | 2.5 | 4.5 | 4.5 |

Local server 303 may be further configured to send the signature to remote server 305. (For example, local server 303 may send the signature to remote server 305 over a network.)

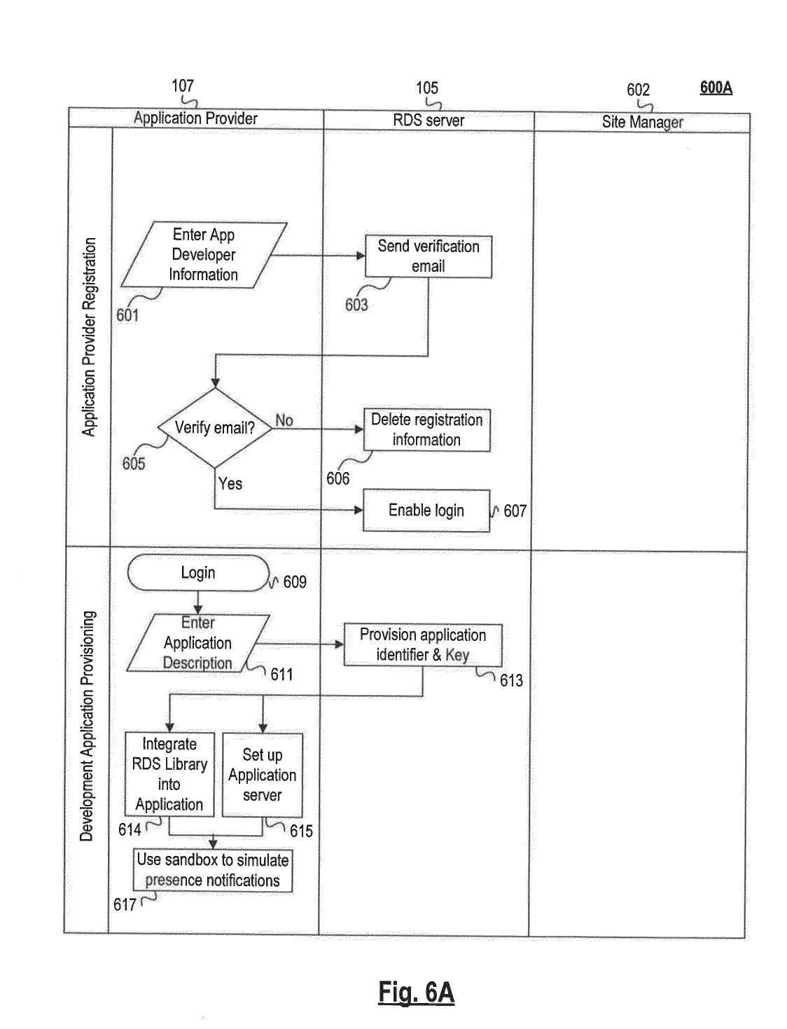

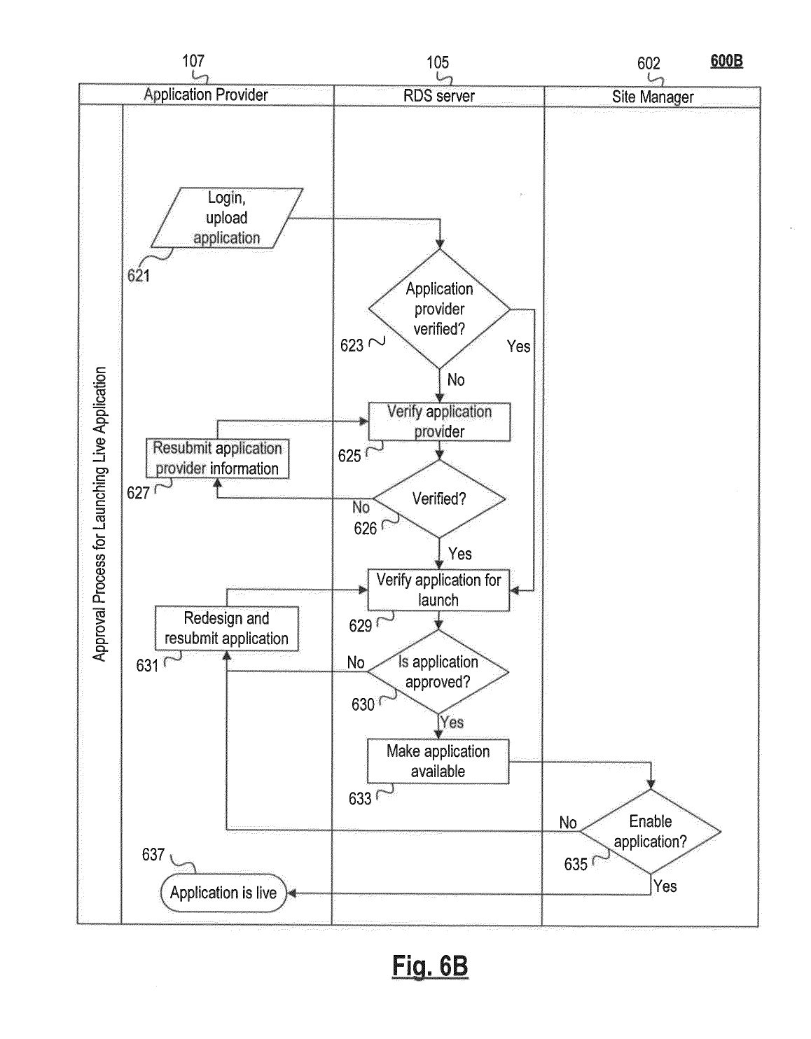

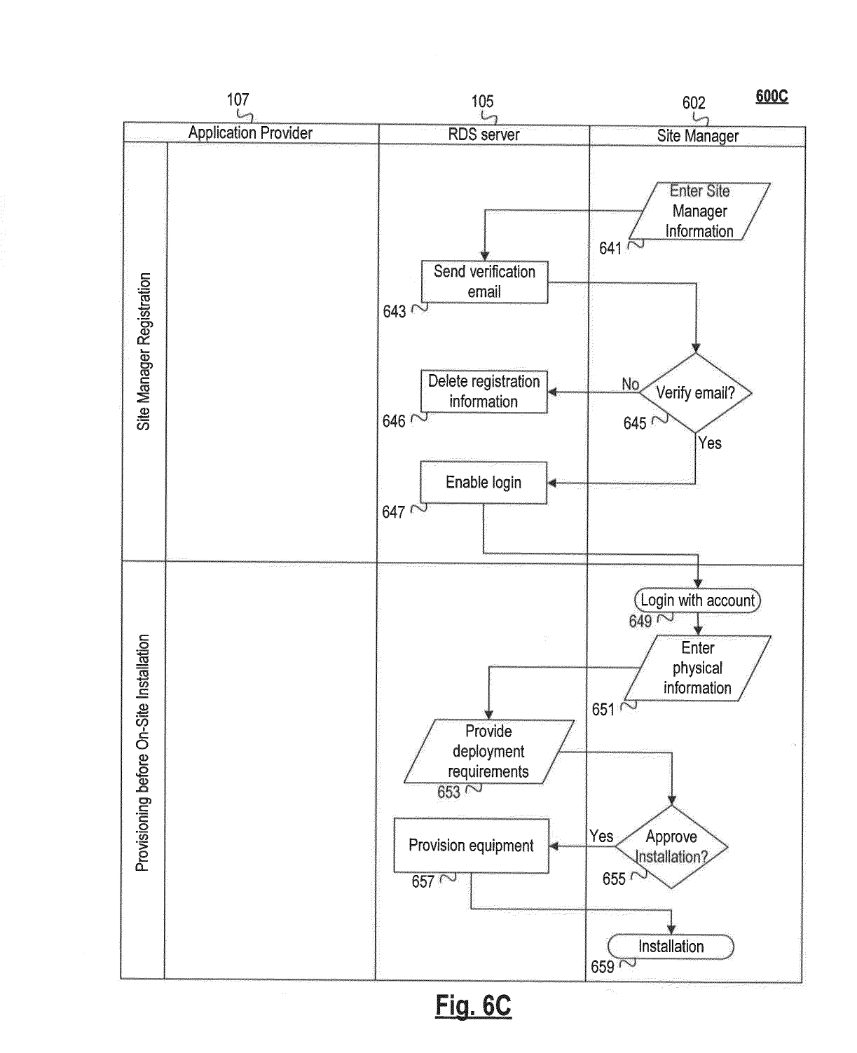

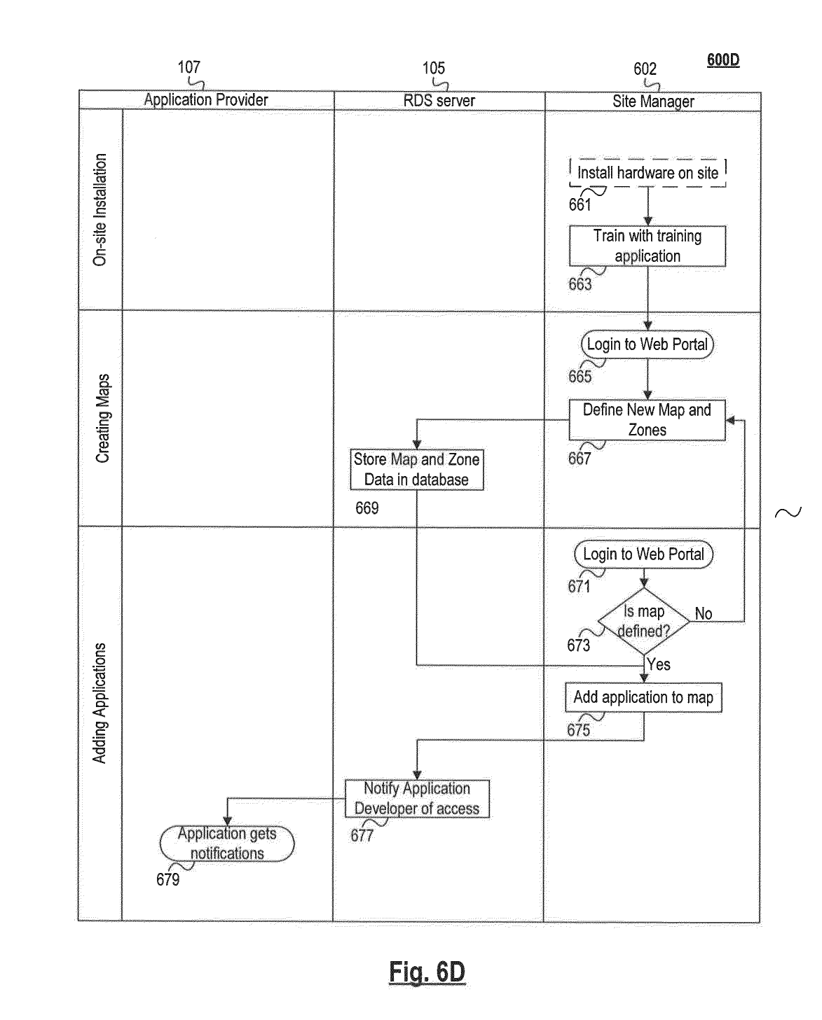

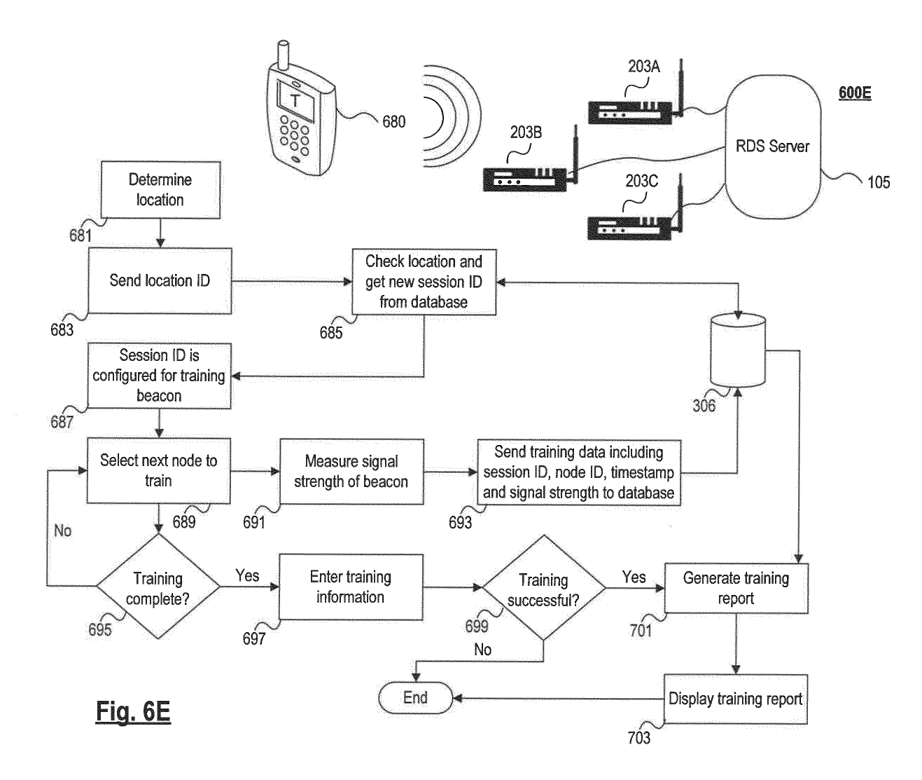

Remote server 305 may comprise one or more devices for determining the location of mobile device 101 based on received signature 302A. (In some embodiments, remote server 305 may be implemented as part of RDS server 105.) Remote server 305 may comprise a database 306 of known signatures. In some embodiments (for example, those referenced below with reference to FIGS. 6D and 6E), database 306 comprises signatures generated based on a mapping process conducted by an individual with a training device (not pictured) configured to send beacons. For example, an individual may walk around a physical space to a variety of (x,y) coordinates in that space (known as “nodes”) while a mobile device sends beacons detection devices 203A-203C from each of those nodes. Remote server 305 may receive the beacons in the form of a “trained” signature associated with each node. The trained signature may be stored in association with the node in database 306.

Remote server 305 may be configured to compare received signature 302A to the signatures in database 306, and may determine where mobile device 101 is based on the comparison. As one example, statistical matching protocols may be used to match signatures. One such protocol is a Mahalanobis distance (a spatially-invariant Euclidean distance). Remote server 305 may implement this protocol as follows. At the end of each “flush,” (e.g., a time period during which packets are collected), a thread summarizing vector (ss′) is generated. Vector ss′ may be the average of all beacon signal strengths collected from a particular mobile device. Remote server 305 may then calculate the distance of this vector to each of the nodes (nⱼ) of the graph. For example, the distance may be calculated as

$$D = {\sum }_{i}^{n} ( 1 - \frac{{SS}_{i}^{′}}{{n}_{j , i}} )$$

Remote server 305 may rank each node and corresponding distances in ascending order, leaving the node with the shortest distance as the best match. In some embodiments, remote server 305 may utilize a modified version of the Mahalanobis distance by removing the square-root operator (as above) to account for large magnitude differences and reduce the complexity of the calculation, or may utilize a fixed threshold to matches that have exceedingly high distance. One advantage of this approach is that it is highly parallelizable and can take advantage of GPU (graphics processor unit) computing technologies such as CUDA and OpenCL. Each computing unit may then compute the distance of the summarizing vector with a subset of grid nodes simultaneously and push these distances to a global priority queue.

Remote server may be configured to compare signature 302A to the trained signatures in database 306 to determine which of the trained signatures in database 306 is most similar to signature 302A. After determining which trained signature is most similar to signature 302A, remote server 305 may then determine the node (i.e., the location in the physical space) associated with the most-similar trained signature, and send the node and/or an associated location (e.g., a relative or absolute location identifier) to mobile device 101 or other devices (e.g., application providers 107 or 109 from FIG. 1) over a network such as network 307 (e.g., the Internet, a wireless network, a cellular network, or the like).

In the illustrated embodiments, local server 303 and remote server 305 are implemented as separate devices; however, in some embodiments, local server 303 and remote server 305 may be combined into a single device (e.g., a single computer system).

Moreover, other embodiments for generating signature 302A and comparing signature 302A to signatures in database 306 are possible as well. For example, signatures may be generated and compared using a k-d tree implementation. (This is discussed below with respect to FIG. 3B.)

FIG. 3B illustrates an exemplary tree 300B for storing signatures, consistent with the disclosed embodiments. Database 306 in FIG. 3A may be implemented as a k-d tree or other binary tree data structure where each element of the tree represents a particular physical location in area 301 (“nodes”) of FIG. 3A. Measurements from each node in the physical location such as a signal signature may be placed into unbalanced binary tree 300B in a hyperspace of k dimensions (k being the number of detection devices 203A-203C). Bisecting planes 311, 313, and 315 (of k−1 dimensions) may separate each element from one another, and may be computed by finding the median (i.e., the average) values at each dimension for each element. Each of these bisections may represent a split in the tree. A bisection of a single element of tree 300B, in some embodiments, may be generated such that one portion of the signatures in that element are represented in one child element, while the remaining signatures are represented in one or more other child elements. The space may have to be bisected repeatedly until only one element exists in each of the subspaces. The subspaces may be known as “leaves” 314A-314F.

When remote server 305 receives the signature 302A, remote server 305 may traverse tree 300B and compute the distance between the signature and each of the bisecting planes, in order to determine which element in the tree to go to next. Once remote server 305 reaches a leaf of the tree, remote server 305 may compute the distance between signature 302A and the signature corresponding to that leaf.

For example, if signature 302A represents a signature that is close to the signature in the “C” leaf, remote server 305 may approach top node 306A which contains an average signature for all of signatures A, B, C, D, E, F, and G (which are stored in leaves 314A-314G, respectively) and determine that signature 302A is closer to the average signature between signatures A, B, C, and D in element 306B than to the average signature between signatures E, F, and G in element 306C. Remote server 305 may then approach node 306B and determine that signature 302A is closer to the average signature between signatures C and Din element 306E than to the average signature between signatures A and B in element 306D. Remote server 305 may then approach node 306E and determine that signature 302A is closer to the signature represented by node C in leaf 314C than the signature represented by node D in leaf 314 D, Remote server 305 may then determine that the mobile device is closest to node C, and determine the location data associated with node C (e.g., a relative or absolute addressing system for the physical space).

FIG. 4 illustrates exemplary processes 400A and 400B for generating Device Specific Identifiers (DSIs) 104, consistent with disclosed embodiments.

Process 400A is an exemplary process by which mobile device 101 generates DSI 104 using on-board processing systems. For example, process 400A may be used by devices that have one or more stand-alone microprocessor(s), memory, power systems, and storage, sufficient to perform the steps to generate DSI 104.

In step 401, mobile device 101 utilizes RDS client 101A (e.g., software, hardware, firmware, or a combination thereof) to generate a DSI. The DSI may be generated using a unique identifier for mobile device 101 in a variety of ways. For example, RDS client 101A may determine an IMEI of mobile device 101. The last digit may be discarded (as it is a check digit or error correction digit). RDS client 101A may then convert the resulting IMEI to a hexadecimal (i.e., base-16) string and perform a hash function on the hexadecimal representation. In some embodiments, the hash function is chosen such that the resulting hash is unique for all inputs. For example, RDS client 101A may swap each even and odd digit with one another (e.g., the first digit with the second digit, the third digit with the fourth digit, etc.) to generate a unique hash value. RDS client 101A may then send the hash value to RDS server 105.

In step 403, RDS server 105 may determine whether or not the received hash value matches a DSI for mobile device 101. For example, RDS server 105 may consult a database to determine whether the hash value matches a pre-determined DSI. RDS server 105 may also generate a confirmation hash value based on knowledge of the IMEI of mobile device 101. In step 405, if RDS server 105 determines that the received hash value and a stored or generated DSI match one another, RDS server 105 may send a confirmation to mobile device 101 indicating that the hash value generated by mobile device 101 and the DSI at RDS server 105 matched one another.

Process 400B is an exemplary process by which an RDS-enabled device (such as mobile device 101) does not generate a DSI. For example, process 400B may be used by devices that lack sufficient equipment to generate a DSI (e.g., where the device is a stand-alone tag, the device is a wearable item such as a fitness tracking device, or the like).

In step 411, in some embodiments, mobile device 101 utilizes RDS client 101A to send a unique identifier to RDS server 105. For example, RDS client 101A may send an IMEI to RDS server 105. In other embodiments, step 411 may be omitted (for example, if mobile device 101 is a stand-alone tag or other device having insufficient processing power to request DSI 104. In these embodiments, a user or another device may request generation of DSI 104 from RDS server 105 for mobile device 101.

In step 413, RDS server 105 may generate a DSI. As explained above, the DSI may be generated in a variety of ways. In step 415, RDS server 105 may send the hash value to mobile device 101. In some embodiments, sending the hash value to mobile device 101 may be accomplished using a network. In other embodiments, for example, where mobile device 101 lacks sufficient processing power to have network connectivity, RDS server 105 (and/or one or other devices such as tag scanners or tag writers) may transfer the generated DSI to mobile device 101 over wired or wireless means. Mobile device 101 may store DSI 104 in memory for future use.

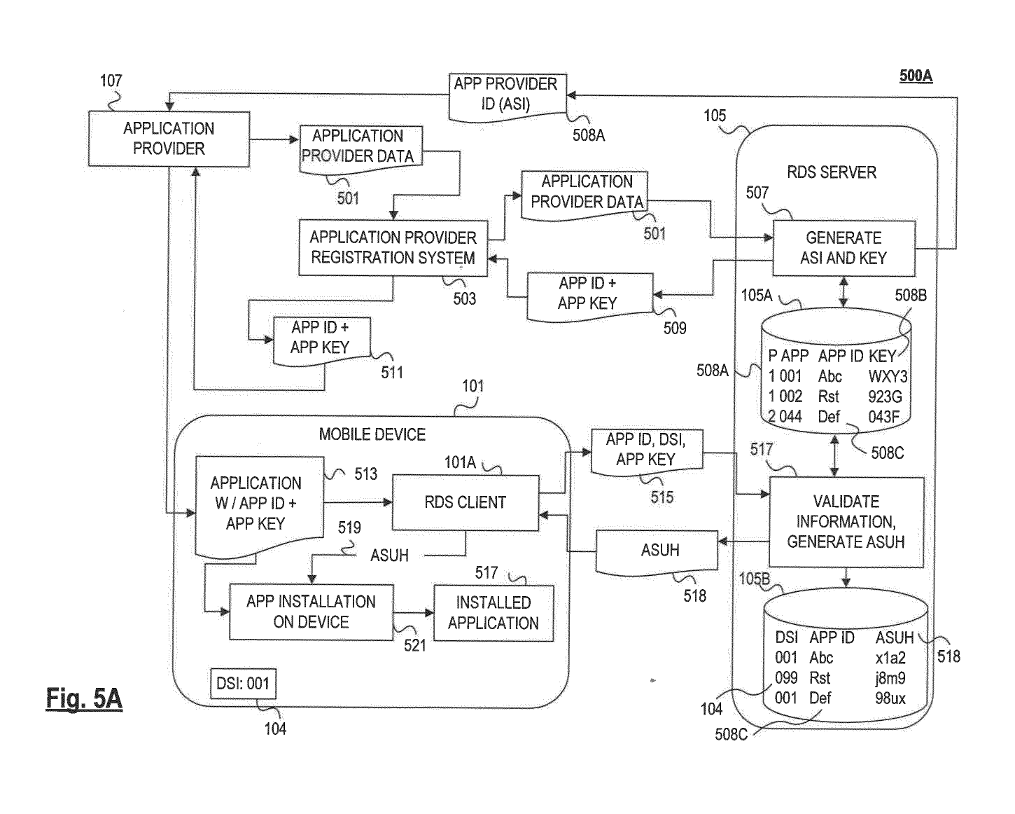

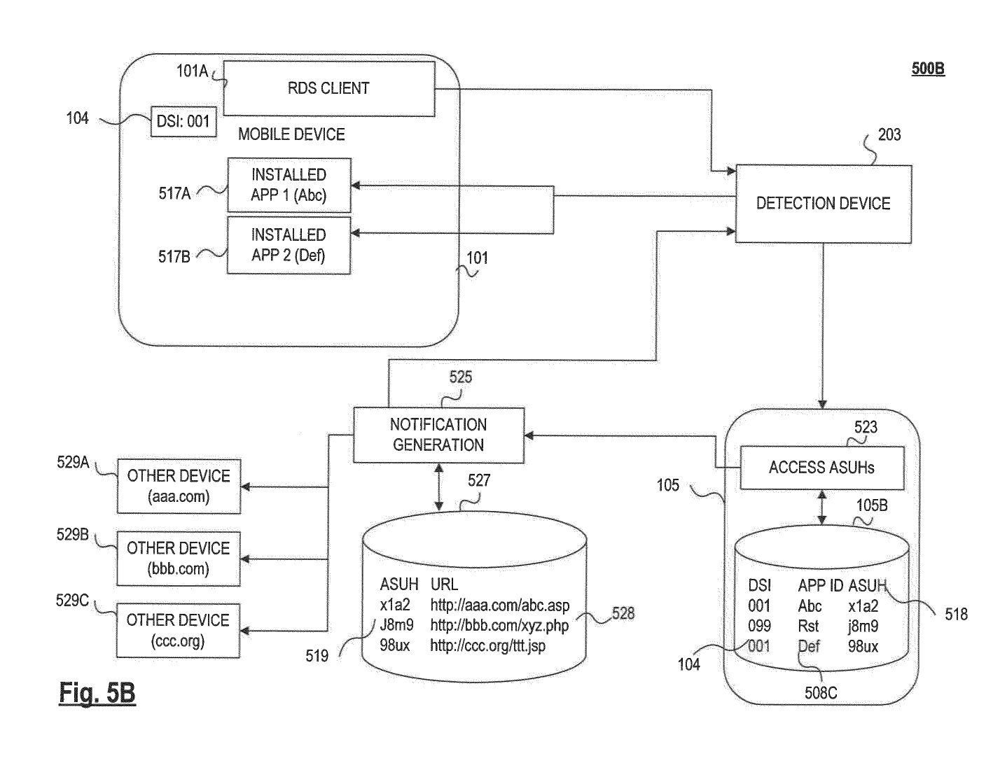

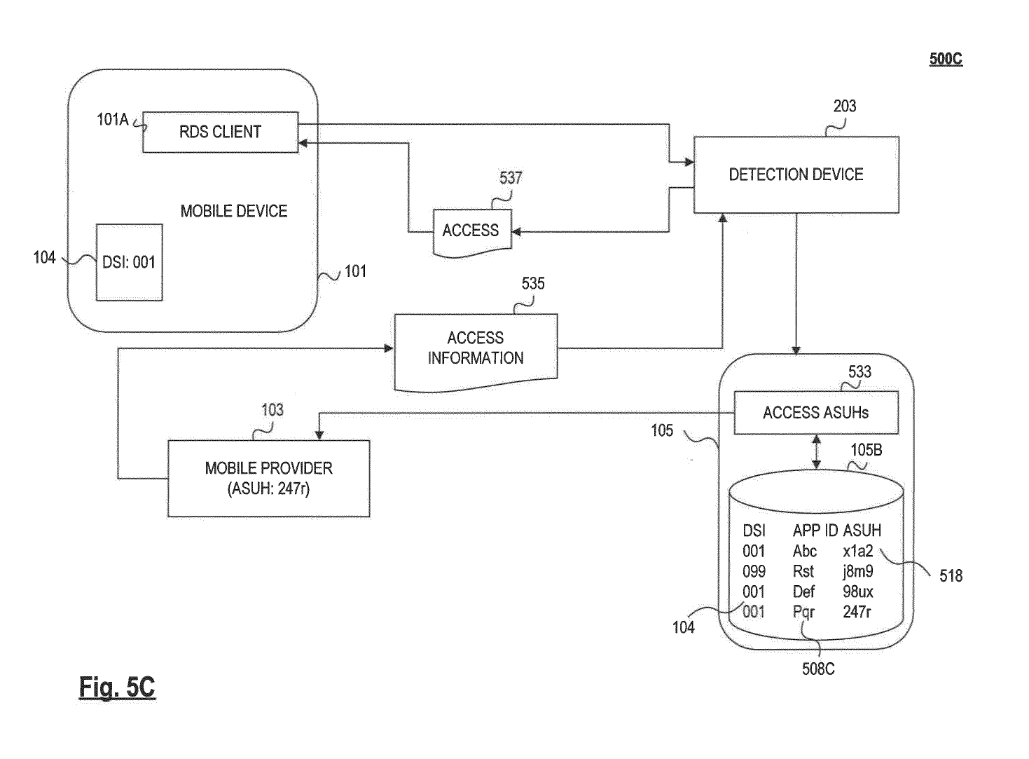

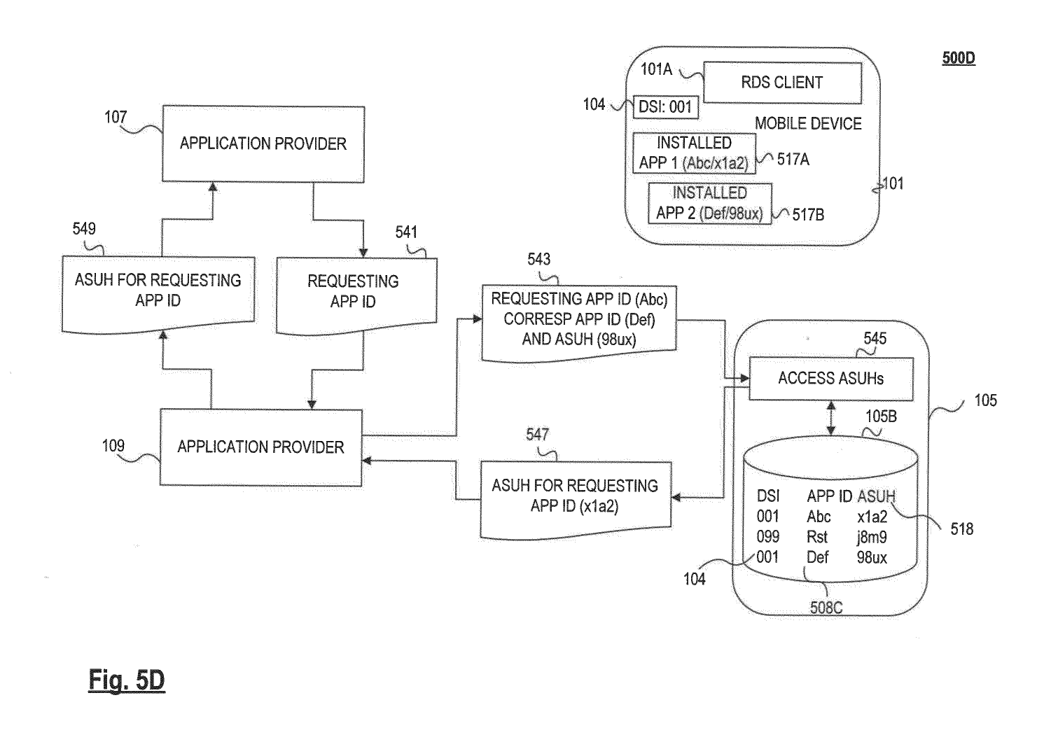

FIG. 5A illustrates an exemplary information flow between a mobile device 101, an application provider 107, an RDS server 105, and an application provider registration system 503, for generating identifiers and installing applications on mobile device 101, consistent with disclosed embodiments.

Application provider 107 may send application provider data 501 to an application provider registration system 503. Data 501 includes, for example, a name of application provider 107 (e.g., “BigSupermarket LLC”), a username and password for authentication, contact information (e.g., responsible party's name, phone number, and address), an identifier for a new application (e.g. “BigSupermarket Coupons ver. 1.0”) or the like. Application provider registration system 503 (which, in some embodiments, may be implemented as part of RDS server 105 or may be implemented as one or more separate devices) receives application provider data 501 and forwards it to RDS server 105. RDS server 105 generates an application provider ID (ASI) 508A and an application key 508B. ASI 508A, in some embodiments, represents a unique identifier for application provider 107. ASI 508A may be used, in some embodiments, to authorize the creation of new application specific user hashes (ASUHs) 518, which represent particular instances of applications installed on mobile device 101 and/or application keys 508B. Application keys 508B, in some embodiments, represent an application referenced in application provider data 501. Application key 508B represents data that is intended for use by application provider 107 to provision an application and provide mobile devices having that application with data related to the application (e.g., location data, coupons, or the like).

After generating ASI 508A and application key 508B, RDS server 105 may store both of ASI 508A and application key 508B in database 105A. Database 105A, which may be implemented as any sort of database (e.g., navigational, relational, XML-based, object-oriented, or the like), may store data related to the ASI 508A and application key 508B. For example, database 105A may store records having a counter for each application provided by application provider 107 (represented by “P”), an ASI 508A for application provider 107 (represented by “APP”), an identifier 508C for an application provided by application provider 107 (represented by “APP ID”), and an application key 508B corresponding to an application provided by application provider 107 (represented by “KEY”). RDS server 105 may also be configured to send ASI 508A to application provider 107. RDS server 105 may also be configured to send application ID 508C and application key 508B to application provider registration system 503 in step 509. Registration system 503 may receive application ID 508C and application key 508B and, in step 511, forward both to application provider 107.

Mobile device 101 may be configured to receive an application 513. In some embodiments, mobile device 101 may request application 513 from application provider 107 (e.g., by browsing to a website, downloading application 513, requesting application 513 from an application store, or the like). In other embodiments, application provider 107 may provide the application to mobile device 101 through another means (e.g., NFC, Wi-Fi, Infrared, or Bluetooth).

In either situation, application 513 on mobile device may comprise application code for running software on mobile device 101. For example, the application code may cause one or more processors to perform actions (e.g., display information on a screen, receive user input or data from a network connection, send data via a network connection, play a sound, or the like). Application 513 may also comprise application ID 508C and application key 508B. For example, application provider 107 may insert application ID 508C and application key 508B into application 513 before mobile device 101 receives application 513. Application 513 may be configured to send application ID 508C and application key 508B to RDS client 101A.

RDS client 101A, in some embodiments, may be implemented as hardware, software, firmware, or a combination thereof. RDS client 101A may be configured to effect communication between application 513, mobile device 101, application provider 107, RDS server 105, or other devices. For example, RDS client 101A may be configured to receive application ID 508C and application key 508B from application 513 as part of an IPC (inter-process communication) message or other means.

In step 515, RDS client 101A may send application ID 508C, application key 508B, and DSI (Device Specific Identifier) 104 to RDS Server 105. As explained above, in some embodiments DSI 104 may be based on an identifier that uniquely identifies mobile device 101, such as an IMP (International Mobile station Equipment Identity) or a MAC (Media Access Control) address.

In step 517, RDS server 105 may receive application ID 508C, application key 508B, and DSI 104 from mobile device 101. For example, RDS server 105 may receive this information over a network such as the Internet. RDS server 105 may then consult database 105A to determine whether the received information is correct. For example, if database 105A is implemented as a relational database, RDS server 105 may determine whether the received application ID 508C and application key 508B are both present in the same record in database 105A. (In other embodiments, for example where database 105A is not implemented as a relational database, RDS server 105 may determine whether the application ID 508C and application key 508B are linked to one another in some other manner.)

If both application ID 508C and application key 508B are determined to be correct, RDS server 105 may generate an ASUH (application specific user hash) 518. In some embodiments, ASUH 518 may represent a combination of a particular instance of application 513, application ID 508C, and application key 508B on mobile device 101. RDS server 105 may also store DSI 104, application ID 508C, and ASUH 518 in database 105B. RDS server 105 may store each of DSI 104, application ID 508C, and ASUH 518 in association with one another (e.g., as a single record in database 105B), In step 519, RDS server 105 may send ASUH 518 to mobile device 101.

RDS client 101A on mobile device 101 may receive ASUH 518. In step 521, RDS client 101A may install application 513, using one or more of application ID 508C, application key 508B, or ASUH 518, as installed application 517. Installed application 517, in some embodiments, may also send ASUH 518 to application provider 107 (e.g., to register the installation of installed application 517). During operation, installed application 517 may communicate with application provider 107 and include ASUH 518 in such communications.

FIG. 5B illustrates an exemplary information flow between a mobile device 101, a detection device 203, a notification generation system 525, an RDS server 105, and other devices 529A-529C, for utilizing an application specific user hash (ASUH) 518, consistent with disclosed embodiments.

RDS client 101A may be configured to generate and send one or more “beacons” at a particular interval. As explained above, each beacon may include DSI 104 associated with mobile device 101. RDS client 101A may be configured to send beacons at varying intervals (e.g., once every 200 milliseconds). In some embodiments, RDS client 101A may send the beacons as a one-way communication (e.g., without waiting for an acknowledgement from another device such as detection device 203).

Detection device 203, in some embodiments, may be implemented as a wireless access point (e.g. IEEE 802.11 or “Wi-Fi”) or in operative connection with such an access point. Detection device 203 may be configured to receive the one or more beacons from mobile device 101. In some embodiments, detection device 203 may collect one or more beacons during a particular period of time, known as a “flush interval” (e.g., 5 seconds) and send each beacon to RDS server 105 at the end of that time period. In other embodiments, detection device 203 may send each beacon as it is received to RDS server 105. Detection device 203 may also send other information with that communication (e.g., a unique or non-unique identifier for detection device 203, a location of detection device 203, a signal strength associated with a received beacon, or a timestamp related to the receipt of the beacon).

RDS server 105 may be configured to receive one or more beacons from detection device 203. In step 523, RDS server 105 may consult database 105B using the received DSI 104 to determine associated ASUHs and application IDs. For example, RDS server 105 may send a SQL (Structured Query Language) query or other query to database 105B including a request for all records having a DSI equal to that received from detection device 203. Database 105B may respond with one or more pairs of application IDs 508C and ASUHs 518. Step 523 also represents RDS server 105 sending data such as the ASUHs 518 or application Ds 508C received from database 105B, location information associated with mobile device 101, an identifier associated with detection device 203, or other information, to notification generation system 525.

Notification generation system 525 represents one or more systems that are configured to receive application IDs 508C and ASUHs 518, and to look up one or more received application IDs 508C or ASUHs 518 in a database such as database 527. In some embodiments, notification generation system 525 may send a SQL query or other query to database 527 requesting URLs 528 that correspond to one or more ASUHs 518 and/or application IDs 5080. In other embodiments, notification generation system 525 may receive URLs 528 that correspond to one or more ASUHs 518 and/or application IDs 508C (e.g., from RDS server 105).

Database 527 includes, in some embodiments, ASUHs 518 and/or application IDs 508C paired with corresponding URLs (Uniform Resource Locators) 528. Database 527 may be configured to respond with one or more URLs 528. Each URL 528 may correspond to one of other device(s) 529. For example, a first URL 528 may represent an Internet address associated with a first application provided by a first application provider, while a second URL 528 may represent an Internet address associated with a second application provided by the first application provider.

Notification generation system 525, upon receiving the corresponding URLs 528 from database 527, may generate and send a communication to the one or more URL(s) 528 corresponding to the one or more ASUH(s) 518. The communication may include, for example, a location associated with mobile device 101, a location associated with detection device 203, a unique identifier of detection device 203 (e.g., DSI 104), or other information. Notification generation system 525 may also send one or more communication(s) to detection device 203. For example, notification generation system 525 may send a communication comprising a request for detection device 203 to provision Wi-Fi access to mobile device 101.

Other devices 529A-529C, in some embodiments, may be implemented as one or more devices for receiving communications from notification generation system 525. For example, each of other devices 529A-529C may be operated or controlled by an application provider (e.g., application provider 107 or 109). (In some embodiments, each of other devices 529A-529C may be operated by a different application provider. In other embodiments, an application provider may operate two or more of other devices 529A-529C. In still other embodiments, two or more application providers may operate a single one of other devices 529A-529C.) Other devices 529A-529C may be associated with one or more of URL(s) 528 in database 527, in that other devices 529A-529C are accessible to devices such as notification generation system 525 and detection device 203 using URL(s) 208. For example, notification generation system 525 may send notifications to a URL in database 527 in order to reach other device(s) 529A-529C.

Other devices 529A-529C may receive a communication from notification generation system 525 and utilize the information in the communication to accomplish one or more functions. As one example, if other device 529A receives a communication from notification generation 525 that includes a location of mobile device 101, other device 529A may generate a relevant communication for sending to mobile device 101 based on the received location, and may send it to mobile device 101 through a network (not pictured). For example, if the communication indicates that mobile device 101 is in the dairy aisle of a particular grocery store, and other device 529A is operated by a coupon provider, other device 529A may generate a coupon reading: “Here is a coupon for $2.00 off of a one-gallon milk container, just for you” and send the coupon to mobile device 101.

As an illustrated example, mobile device 101 has a DSI 104 of “001” and transmits one or more beacons to detection device 203 including DSI 104. Detection device 203 may forward the received beacons to RDS server 105. RDS server 105 may consult database 105B and determine that database 105B has two entries with the received DSI: one with an application ID of “Abc” and an ASUH of “x1a2,” and one with an application ID of “Def” and an ASUH of “98ux.” RDS server 105 may send a first communication to notification generation system 525 including an application ID of “Abc” and an ASUH of “x1a2,” and send a second communication to notification generation system 525 including an application ID of “Def” and an ASUH of “98ux.” Notification generation system 525 may receive the first communication and determine that the ASUH of “x1a2” corresponds to “http://aaa.com/abc.asp,” and may forward the first communication to other device 529A. Notification generation system 525 may receive the second communication and determine that the ASUH of “98ux” corresponds to “http://ccc.org/ttt.jsp,” and may forward the second communication to other device 529C. Other devices 529A and 529C may generate and send communications to mobile device 101, such as coupons or offers to buy products. Notification generation system 525 may also forward the first communication and second communication to detection device 203. Detection device 203 may receive the first communication and second communication and send information back to mobile device 101. For example, detection device 203 may send back location information, cached content relevant to a location of mobile device 101, or other information.

FIG. 5C illustrates an exemplary information flow between a mobile device 101, a detection device 203, an RDS server 105, and a mobile provider 103, for provisioning wireless access using detection device 203, consistent with disclosed embodiments.

Mobile device 101 may comprise RDS client 101A and DSI 104. RDS client 101A may be configured to send one or more beacons comprising DSI 104 to detection device 203. Mobile device 101 includes functionality and hardware usable to utilize a wireless network for network communication (e.g. IEEE 802.11 wireless). Mobile device 101 may also be configured to turn on and off other devices that are attached to or part of mobile device 101 based on instructions received over such a wireless network. For example, mobile device 101 may be configured to turn off a cellular data network radio (e.g., a “3G” or “LTE” radio) when the device receives a communication indicating that another form of wireless communication (e.g., IEEE 802.11 or “Wi-Fi”) is available. This turning on and off of radios may be based on a location of mobile device 101 (e.g., when entering a building having poor cellular network connectivity), data received from sensors in communication with mobile device 101 (e.g., gyroscopes or GPS-based sensors), data received from detection device 203 or mobile provider 103, or the like.

Detection device 203, in some embodiments, may be implemented as a wireless access point (e.g. IEEE 802.11 wireless). Detection device 203 may be configured to receive the one or more beacons from mobile device 101. Detection device 203 may collect one or more beacons during a particular period of time (e.g., 5 seconds) and send each beacon to RDS server 105 at the end of that time period, or may send each beacon to RDS server 105 as it is received. Detection device 203 may also send other information with that communication (e.g., a unique or non-unique identifier for detection device 203, DSI 104, a location of detection device 203, or location data associated with mobile device 101.

Detection device 203 may be configured to provision access 537 to mobile device 101 by sending information comprising one or more pieces of data necessary to enable mobile device 101 to access a network. For example, detection device 203 may send a password necessary to access the network (e.g., a Wi-Fi password or a password to authenticate at a web page) or a Service Set Identifier (SSID) identifying a network for use by mobile device 101.

RDS server 105 may be configured to receive one or more beacons from detection device 203. In step 533, RDS server 105 may consult database 105B using a received DSI 104 to determine associated ASUHs and application IDs. For example, RDS server 105 may send a SQL (Structured Query Language) query or other query to database 105B including a request for all records having a DSI equal to the received DSI. Database 105B may respond with one or more pairs of application IDs 508C and ASUHs 518. Step 533 also represents RDS server 105 sending data such as the ASUHs 518 or application IDs 508C received from database 105B, location information associated with mobile device 101, an identifier associated with detection device 203, or other information, to mobile provider 103, (In some embodiments, RDS server 105 may send that information to another device, such as notification generation server 525 from FIG. 5B, for sending to mobile provider 103.)

Mobile provider 103, in some embodiments, represents a provider of network services for mobile device 101. In some embodiments, mobile device 101 is a smartphone or cellular phone and mobile provider 103 is a wireless carrier that provides data and/or voice services to mobile device 101, for example, using network technologies such as LTE- or 3G-based wireless communication. In other embodiments, mobile device 101 is a wireless (e.g., IEEE 802.11 or “Wi-Fi”) device that receives data only over wireless networks, and mobile provider 103 is a network of affiliated wireless “hotspots” or networks that enable wireless access. Mobile provider 103 may be associated with an ASUH (application specific user hash) 518 and a provider hash 102 (as in FIG. 1) that corresponds to a relationship between mobile provider 103 and mobile device 101.

Mobile provider 103 may be configured to provide access information 535 to detection device 203 to enable detection device (or another device such as a wireless access point) to provide wireless network access to mobile device 101. As one example, mobile device 101 may be associated with an account that provides five hours of wireless access per month, and that charges the user $5.00 per hour thereafter. In this example, access information 535 may comprise instructions operable to configure detection device 203 to provide five hours' worth of wireless access to mobile device 101. As another example, mobile device 101 may be configured to turn off a cellular radio (not pictured) in mobile device 101 when entering particular buildings to save on battery life (as cellular radios may not operate in all indoor locations). In this example, access information 535 may comprise instructions operable to configure detection device 203 to instruct mobile device 101 to turn off a cellular radio and to begin accessing a wireless network provided by detection device 203.

As an illustrative example, a user may carry mobile device 101 into a building such as a shopping center or similar structure having one or more detection devices 203. Mobile device 101 may transmit one or more beacons comprising DSI 104 (“001”). Detection device 203 may receive the one or more beacons comprising DSI 104 and transmit them to RDS server 105. RDS server 105 may access database 105B to determine whether DSI 104 in the received beacons is included in database 105B. RDS server 105 may then determine corresponding ASUH (“247r”) which corresponds to mobile provider 103, and send a communication to mobile provider 103 indicating that mobile device 101 is in range of a wireless network. Mobile provider 103 may send access information 535 to detection device 203, indicating that mobile device 101 is able to access a wireless network provided by detection device 203. Detection device 203 may provision access 537 to mobile device by sending a wireless password necessary to log onto the network.

FIG. 5D illustrates an exemplary information flow between two application providers 107 and 109 and RDS server 105, for sharing of user-specific data between applications 517A and 517B, consistent with disclosed embodiments.

Application providers 107 and 109 may provide applications 517A and 517B, respectively, for use with mobile devices such as mobile device 101. Each of these applications may be associated with a respective application ID 508C. As one example, application provider 107 may be operated by a retailer with a physical location (such as a mall, shopping center, or similar structure) and application 517A may be a self-checkout application, a coupon application, or a product information application. Application provider 109 may be operated by a targeted advertisement company and application 517B may be an advertisement application (providing mobile device 101 with, for example, popup advertisements or SMS-based advertisements).

In step 541, application provider 107 may initiate a process to share information between applications 517A and 517B, by sending an application ID 508C associated with application 517A to application provider 109. In step 543, application provider 109 may generate and send a communication to RDS server 105. The communication includes, in some embodiments, an application ID associated with application 517A (i.e., the application provided by application provider 107), an application ID associated with application 517B (i.e., the application provided by application provider 109), and an ASUH associated with application 517B (i.e., the ASUH associated with the instance of application 517B installed on mobile device 101).

In step 545, RDS server 105 may consult database 105B using received application IDs and a received ASUH to enable information sharing between applications. For example, step 545 may represent RDS server 105 sending a SQL (Structured Query Language) query or other query to database 105B including a request for all records having an application ID equal to the application ID associated with application 517B. Database 105B may respond with one or more records having application IDs 508C and ASUHs 518. RDS server 105 may then determine whether one of the received pairs matches the received information. For example, RDS server 105 may determine whether a received pair having an application ID equal to the application ID received from application provider 109 has an ASUH equal to the ASUH received from application provider 109. If so, RDS server 105 may send a second query to database 105B including a request for all records having an application ID equal to the application ID associated with application 517A. Database 105B may respond with one or more records having application Ds 508C and ASUHs 518. Step 545 also comprises RDS server determining which of the records has an application ID equal to the application ID associated with application 517A.

In step 547, RDS server 105 may send corresponding ASUHs 518 to application provider 109. Application provider 109 may receive the ASUH associated with the instance of application 517A and, in step 549, send it to application provider 107.

Embodiments of FIG. 5D are useful, for example, if application provider 107 and application provider 109 wish to share information with one another. For example, when a mobile device enters a physical location associated with application provider 107, application provider 109 may receive a communication from RDS server 105 indicating the location of the mobile device.

FIG. 6A illustrates an exemplary process 600A for generating an application ID for use by an application provider 107 and an RDS server 105, consistent with disclosed embodiments.

In some embodiments, application provider 107 may develop applications for use with the disclosed embodiments. In other embodiments, another entity (such as an application developer) may develop applications on behalf of application provider 107. In step 601, application provider 107 may send information to RDS server 105. For example, application provider 107 may include a name of application provider 107 (e.g., “BigSupermarket LLC”), a username and password for authentication, contact information (e.g., responsible party's name, phone number, and address), or the like.

In step 603, RDS server 105 may receive the information from application provider 107. RDS server 105 may also generate and send a verification email to application provider 107. The verification email, in some embodiments, includes a request for application provider 107 to confirm the information provided by application developer 107 in step 601. The verification email may also include terms and conditions that application provider 107 must agree to. In step 605, application provider 107 may respond to the verification email by sending a communication to RDS server 105 (e.g., by sending an email or visiting a particular web page). In step 607, RDS server may receive the response to the verification email and enable the username and password received in step 603. If, on the other hand, application provider 107 does not respond to the verification email within a set amount of time or responds to the email in the negative, RDS server 105 may delete the information received in step 603.

In step 609, application provider 107 may perform a login procedure with RDS server 105 (e.g., using the username and password it provided to RDS server 105 in step 601). In step 611, application provider may generate and send a communication comprising information related to an application. (This application may be one of the applications depicted in, for example, FIG. 5A, 5B, or 5D.) This communication, in some embodiments, comprises information related to the application, such as a name of the application (e.g., “CouponApp”), a description of the platform that the application is implemented on (e.g., iOS, Android, Blackberry, Windows Mobile), a description related to the application (e.g., “This application provides valuable coupons when the our customers enter any aisle in any one of BigSupermarket LLC's 678 stores nationwide.”), a server address associated with the application (e.g., a URL or IP address for enabling communications to and from mobile devices using the application), or the like.

In step 613, RDS server 105 receives the communication from application provider 107. RDS server 105 also generates an application ID 508C and an application key 508B, and sends both to application provider 107. Application provider 107 receives application ID 508C and application key 508B from RDS server 105.

In step 614, application provider 107 integrates one or more code libraries into the application references in step 611. For example, RDS server 105 may make one or more code libraries accessible to application provider 107 to ease integration of functionality into applications it wishes to provide. In step 615, application provider 107 may set up a server to enable communications to and from mobile device 101 using the application. For example, the server may be implemented as a system for receiving DSIs and/or other data from RDS Server 105, determining a coupon based on the DSI and a profile associated with the user of mobile device 101, and sends a coupon to mobile device 101 using e-mail, SMS, or the like.

In step 617, application provider 107 may utilize a “sandbox” or simulation environment in order to test out the application before sending it to one or more mobile devices. As one example, application provider 107 may generate simulated location data from simulated mobile devices, in order to determine the type of data received by application provider 107, mobile device 101, and/or RDS server 105, and to refine the application accordingly

FIG. 6B illustrates an exemplary process for approving an application for use with disclosed systems, consistent with disclosed embodiments. In step 621, application provider 107 may log in to RDS server 105 and upload a new application for approval to RDS server 105. In step 623, RDS server 105 may determine whether application provider 107 has been verified. If not, the process may continue to step 625, where application provider 107 may be verified. Verifying application provider 107 comprises, for example, verifying a street address or email address associated with application provider 107, performing a credit check or a background investigation on application provider 107 or a responsible party (e.g., an owner of application provider 107), or the like. If application provider 107 is not verified, the process continues to step 627, where application provider 107 may resubmit information (e.g., as in step 601 in FIG. 6A).

If application provider 107 is verified, the process may continue to step 629. In step 629, after verifying application provider 107, RDS server verifies the application received from application provider 107. Verifying the application may comprise testing the application to see if it passes internal guidelines or requirement. For example, RDS server 105 or a human tester may perform tests related to battery usage, an average number of notifications that may be sent to a mobile device, or the like. If the application is not approved (step 630), the process continues to step 631 where application provider 107 may redesign and resubmit the application. If the application is approved, however, the process continues to step 633.

In step 633, once the application is approved, RDS server 105 may make the application available for use by other devices such as retailers or other site manager 602. For example, after application provider 107 creates the application and it is approved, an operator of a particular store may utilize the application. In step 635, site manager 602 may enable the application. Enabling the application may comprise, for example, receiving an indication from a party that owns, operates, or otherwise administers a store location. This enables that party to receive notification of the presence of mobile devices once those mobile devices enter the store location.

Once enabled, RDS server 101 may send a communication to application provider 107 indicating that the application is ready for use by mobile devices at the physical spaces owned, operated or administered by site manager 602.

FIG. 6C illustrates an exemplary process for detection device installation and registration of a physical space, consistent with disclosed embodiments. Embodiments of FIG. 6C may be used to provide equipment requirements for physical spaces that site manager 602 owns, operates, or administers, to enable embodiments of the present disclosure to operate in those spaces.

In step 641, site manager 602 enters information for registering with RDS server 105. The physical site may be a defined location, such as a retail store operated by a retailer, an aisle in a store, a department in a department store, or any other location or portion of a physical space. The information may comprise information such as a name of site manager 602 (e.g., “BigSupermarket Store #601” or “Mom and Pop's Bakery on Elm Street”), a username and password for authentication, contact information (e.g., a responsible party's name, a phone number, and an address), or the like. Site manager 602 may send the information to RDS server 105.

In step 643, RDS server 105 may receive the information from site manager 602. RDS server 105 may also generate and send a verification email to site manager 602. The verification email, in some embodiments, includes a request for site manager 602 to confirm the information provided by site manager 602 in step 641. The verification email may also include terms and conditions that site manager 602 must agree to. In step 645, site manager 602 may respond to the verification email by sending a communication to RDS server 105 (e.g., by sending an email or visiting a particular web page). In step 647, RDS server may receive the response to the verification email and enable the username and password received in step 643. If, on the other hand, site manager 602 does not respond to the verification email within a set amount of time or responds to the email in the negative, then in step 646, RDS server 105 may delete the information received in step 643.

In step 649, site manager 602 may perform a login procedure with RDS server 105 (e.g., using the username and password it provided to RDS server 105 in step 641). In step 651, site manager 602 may generate and send a communication to RDS server 105. The communication may comprise information about the physical space owned, operated, or administered by site manager 602. This communication may include, for example, a description of the physical space (e.g., materials used in construction of the physical space, amount of space between aisles, potential radio interference information), an address of the physical space (e.g., a street address), GPS coordinates of the physical space, floor plans (e.g., architectural designs for the budding, layouts of equipment or other items on a sales floor or in a particular portion), dimensions of the physical space (e.g., “60 feet×50 feet×22 feet”), or the like.

In step 653, RDS server 105 may determine deployment requirements for site manager 602. Deployment requirements include the necessary infrastructure to implement the disclosed embodiments at a physical space owned, operated, or administered by site manager 602. For example, based on the information received in step 651, RDS server 105 may determine the number of detection devices (e.g., access points) necessary, the number of power outlets necessary, the cost to purchase, acquire, and set up the detection devices and other equipment, or the like, and send that information to site manager 602. In step 655, site manager 602 may approve the installation (e.g., by sending a communication such as an email) to RDS server 105. In step 657, RDS server 105 may initiate a procedure to provision the necessary hardware (e.g., detection devices, access points, computer, power equipment, or the like). For example, RDS server 105 may ship equipment to site manager 602 or send a communication to site manager 602 including equipment to buy, software to install, or firmware to upgrade current equipment with. Site manager 602 may install the equipment in step 659.

FIG. 6D illustrates an exemplary process for defining a map for a physical site and enabling application access, consistent with disclosed embodiments.

Process 600D begins with optional step 661. In step 661, hardware (such as access points, detection devices, computers, and power equipment) may be installed in a physical space owned, operated, or administered by site manager 602. In some situations, the physical space may already have sufficient hardware to implement embodiments of the disclosure without further physical installation. In other situations, the physical space may not have sufficient hardware. In those situations, another entity (e.g., RDS server 105 or someone working on behalf of RDS server 105) may need to visit the physical space to install the hardware.

In step 663, a trainer may train the hardware using a training application. For example, a person carrying a mobile device (e.g., with special software) may walk around the physical space. The mobile device may take measurements at particular locations on the physical space. The measurements may include, for example, signal strength in a connection between the mobile device and a detection device. (FIG. 6E contains more details on an exemplary method for taking such measurements.)

In step 665, site manage 602 may log in to a web portal or other system to upload the information from the training process in step 663. In step 667, site manager 602 may define a new map and one or more zones based on the recorded measurements. In this context, a map represents the physical layout of the space. This may include architectural features, such as walls, windows, or doors in a given space. Additional information related to, for example, furniture, cabinets, and cubicle walls may also be part of the map. The architectural space can have overlay zones defined on a map. For example, a map of a house may have separate zones defined for the kitchen, each bedroom, and each bathroom.

Site manager 602 may then, in step 667, send the map and zone data to RDS server 105 for storing in a database (such as database 306 in FIG. 3A).

In step 671, site manager 602 may log in to the web portal again in order to add an application to the map and zones defined in step 667. Adding a new application, in some embodiments, may comprise associating one or more actions that may take place when a mobile device is at a particular location in the physical space.

In step 673, site manager 602 determines whether the map and zones have been defined. If not, site manager 602 may be prompted to define a map and/or one or more zones as in step 667 before proceeding to step 675. In step 675, site manager 602 may add a new application to the map by sending one or more communications to RDS server 105. For example, if site manager 602 operates a supermarket, and the supermarket is attempting to sell more bread, site manager 602 may configure one or more applications to send discounts for bread to mobile devices that are detected at detection devices within 20 feet of the bakery department in the supermarket.

In step 677, RDS server 105 may generate a communication indicating that site manager 602 added an application provided by application provider 107 to a map for a physical space owned operated, or administered by site manager 102, and may send the communication to application provider 107. In step 679, application provider 107 may begin to receive notifications from detection devices at the physical space of site manager 602.

FIG. 6E illustrates an exemplary training process 600E, consistent with disclosed embodiments.

A mobile beacon training device 680 may comprise a mobile device such as mobile device 101. An individual may walk around a defined area with training device 680 in order to take measurements at a variety of points in a physical space owned, operated, or administered by site manager 602. Training may commence in step 681, during which training device 680 receives a location. For example, an individual holding the training device may input a location (e.g., a street address, a store name, or a store number). The training device may also use sensors (e.g., GPS, 802.11 wireless, or the like) to determine a current location. In step 683, training device 680 may transmit a location ID to a server (such as RDS server 105). The location ID, in some embodiments, may be a unique identifier for the physical location (such as latitude/longitude coordinates) or some other predefined location identifier for a location. (For example, if training device 680 is in store #506 of BigSupermarkets LLC, the location ID may be “BigSupermarkets-506.”)

In step 685, RDS server 105 may receive the location ID and other information from training device 680. In response, RDS server 105 may get a new training session ID from database 306. This enables the measurements received from training device 680 to add data and/or overwrite previous data with new measurements taken during the process illustrated in FIG. 6E.

In step 687, RDS server 105 may send the training session ID to training device 680. In step 689, training device 680 may begin a training process using the training ID received in step 687. There are many ways of beginning a training process. For example, training device 680 may receive one or more identifiers indicating a “node” (e.g., a particular location) to take measurements from. Training device 680 may provide a map of the physical space owned, operated, or administered by site manager 602 to the user holding training device 680, and instructs the user to approach that location. In other embodiments, the user may select a particular node and enter a code corresponding to that node before approaching that node.

In either case, after approaching the node, training device 680 sends one or more beacons for receipt by detection devices 203A, 203B, and 203C. The beacons include, for example, a DSI associated with training device 680, the session ID received in step 687, a node ID associated with a current physical location of training device 680. Detection devices 203A-203C may receive the beacons from training device 680 and measure the signal strength (e.g., RSSI (Received Signal Strength Indication)) associated with each received beacon. In step 693, each of detection devices 203A-203C may send training data to database 306. The training data includes, for example, the training session ID, the node ID associated with the physical location of training device 680, a timestamp (e.g., date and time), and the signal strength associated with each beacon.

In step 695, training device 680 determines whether or not training is complete for the physical space. For example, training device 680 may determine whether each node on the map associated with the space has been visited or has otherwise had one or more signal strength measurements taken. If not, the process returns to step 689 where the training device 680 may prompt a user to visit a different node. If each node has been visited, the process continues to step 697 where the user of training device 680 can enter training information. Training information includes, for example, pausing the training session, completing the training session, or adding notes on the data collected during the current training session. Moreover, f each node has been visited, the session ID corresponding to the current training session may be disabled or deactivated. This enables the training device to be utilized in non-training mode (e.g., beacons sent to detection devices 203A-203C do not necessarily overwrite data already in database 306).

In step 699, RDS server 105 may determine whether the training was successful. For example, RDS server 105 may determine whether each node was visited and whether sufficient data was gathered from training device 680. If so, process 600E may continue to step 701 where a training report may be generated by one or both of RDS server 105 and database 306. The training report may comprise, for example, a signal visualization of the space, a “fit metric” of how well the measurements match predicted values, a “comparison metric and/or map” of how the current measurements compare to past measurements, or a k-fold comparison metric to itself to determine how well part of the dataset compares to the balance of the data. In step 703, RDS server 105 or training device 680 may display the training report.

FIG. 7A illustrates an exemplary user interface 700A for enabling and disabling RDS access on an RDS-enabled mobile device, consistent with disclosed embodiments. In some embodiments, user interface 700A may be implemented on a mobile device including a touchscreen (not pictured) but not all embodiments require a touchscreen. For example, embodiments of user interface 700A may be implemented on devices lacking a touch screen; devices having a keyboard, trackball, or joystick; devices having switches or toggles; or the like.

Options 705 enable a user of a mobile device to change settings on the mobile device. For example, options 705 include the ability to toggle a Wi-Fi radio (e.g., 802.11) connectivity, mobile hotspot functionality (e.g., enabling computers or other devices to access an Internet connection through the mobile device), a Bluetooth radio, or RDS functionality (e.g., the embodiments of the present disclosure). In some embodiments, each of the individual features in options 705 may be independently enabled or disabled. Moreover, if a user presses on one of options 705 (rather than on the switch for that option), the screen of mobile device may display a different user interface such as user interface 700B in FIG. 7B.

FIG. 7B illustrates an exemplary user interface 700B for enabling and disabling RDS access to particular applications on a mobile device, consistent with disclosed embodiments. A user may utilize user interface 700B on mobile device 101 to enable or disable RDS (Remote Data Services) for one or more applications installed on the mobile device. For example, the user may toggle switch 711 to disable all RDS access for all applications. As another example, the user may toggle any of switches 715 to disable or enable access by a particular application. In either case, mobile device 101 may send the choices to RDS server 105, which may utilize the choices to determine which application providers should receive information about a location associated with mobile device 101.

FIG. 8A illustrates an exemplary process 800A consistent with disclosed embodiments. Process 800A is an exemplary use case for embodiments of the present disclosure, and is for illustrative rather than restrictive purposes. Moreover, features of the embodiments explained with respect to FIG. 8A may be combed with features from other figures or other embodiments as appropriate.

In step 801, an employee may arrive for work. As one example, the employee may be an hourly (i.e., not annually-compensated) worker that is required to be present at a job for a certain amount of time and is compensated based on that amount of time. As another example, the employee may have a position that requires knowledge of the employee's whereabouts at all times (e.g., a security detail for a VIP, a doctor making rounds in the emergency room, a chemical engineer handling high-temperature and other hazardous materials, or an employee working at a nuclear power plant). When the employee arrives at work, in step 803, the employee may check in at work to indicate presence. For example, the employee may scan an identity badge, utilize a mobile phone to send a communication, enter a username and/or password, or the like.

In step 805, a wearable device may be delivered to the employee. For example, after checking in, a supervisor or equipment manager may give a wearable device to the employee. The wearable device may be implemented as a mobile device 101, as described above. In particular embodiments the wearable device may have other features. For example, if the employee works at a nuclear power plant, the wearable device may include a Geiger counter or other radiation dosimeter. Step 805 may also represent a server, such as RDS server 105, storing an association between an identifier of the wearable device (e.g., a DSI 104) and an employee identity (e.g., an employee number, a username, or the like).

In step 807, the employee wears the wearable device and begins work. As the employee walks, rides, or otherwise travels around the workplace, access points (or other detection devices) receive beacons from the wearable device. As explained above, the beacons may include an identifier associated with the wearable device (such as a DSI 104). In step 809, the detection devices may transmit data included in the received beacons to a server such as RDS server 105. RDS server 105 may determine an identity of the employee (e.g., based on the stored association between the wearable device and the employee identity). In step 811, RDS server 105 may store the information from the beacons as well as determined information (e.g., location, based on the information from the beacons) with the determined identity.

After a day's work, the employee may decide to leave work. Step 813 represents the employee checking out from work (e.g., ending a shift or taking a break). The employee returns the wearable device to a central location. In step 815, the employee's identity is unassigned with the identity of the wearable device. This enables reuse of the wearable device to track a different employee. In step 817, a supervisor or equipment manager may charge the wearable device, for example, by placing the device into a cradle.

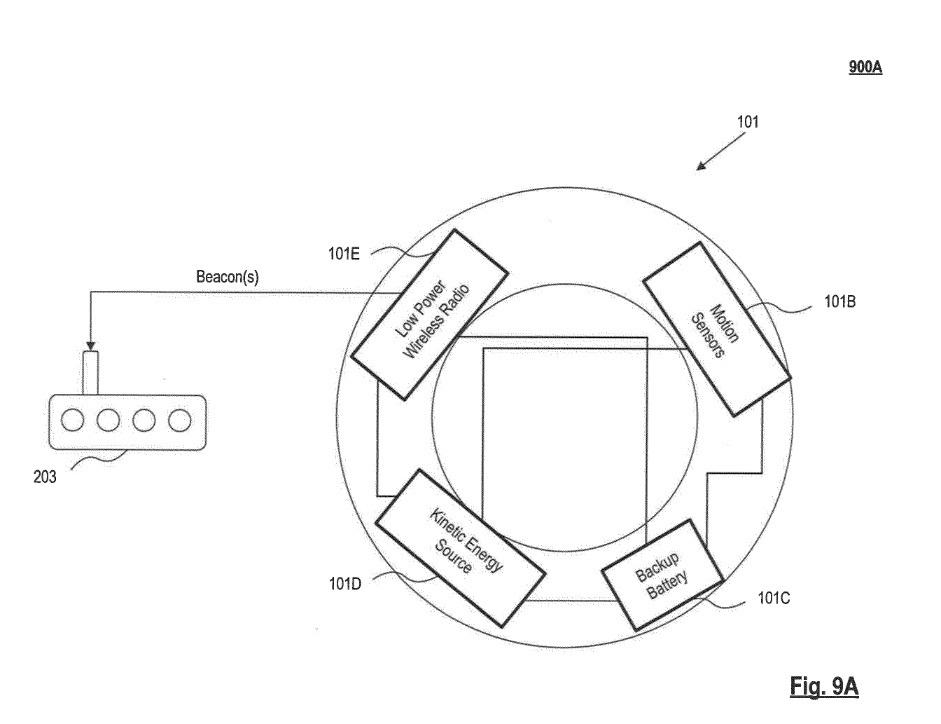

FIG. 9A illustrates an exemplary process for transmitting data between mobile device 101 and detection device 203, consistent with disclosed embodiments.

Mobile device 101, in some embodiments may comprise motion sensors 101B, a backup battery 101C, a kinetic energy source 101D, and a low-power wireless radio 101E. In some embodiments, mobile device 101 may be implemented as a wearable device, such as a watch, ring, wristband, or other device intended to be worn on a user's body.

Motion sensors 101B may be implemented as one or more devices for detecting motion of mobile device 101. For example, motion sensors 101B may be implemented as one or more of accelerometers (e.g., devices that measure linear acceleration and/or tilt angles of an item), gyroscopes (e.g., devices that measure the rotation of an item), pressure sensors (e.g., devices that measure altitude), or magnetic sensors (e.g., devices that measure magnetic fields such as a compass). Motion sensors 101B may send motion data to low-power wireless radio 101E and may receive power from one or both of kinetic energy source 101D or backup battery 101C.

Backup batten 101C may be implemented as one or more batteries providing power to mobile device 101. For example, backup battery 101C may provide power to other components of mobile device 101 when kinetic energy source 101D is not operating, or when kinetic energy source 101D is not providing enough power. Backup battery 101C may be implemented as, for example, a lithium-ion battery, but other types of batteries are possible as well.

Kinetic energy source 101D may be implemented as one or more devices for providing power to mobile device 101. For example, kinetic energy source 101D may be implemented as a magnetic device that produces power when mobile device 101 is in motion. Kinetic energy source 101D may also be configured to provide power to backup battery 101C in order to charge it.

Low-power wireless radio 101E may be implemented as a wireless radio device configured to send information using wireless protocols. For example, low-power wireless radio 101E may be configured to draw power from one or both of kinetic energy source 101D or backup battery 101C, in order to send beacons to detection device 203 at certain intervals. In some embodiments, low-power wireless radio 101E may be implemented as a radio separate from a wireless radio used for communication by a user of mobile device 101 (e.g., an 802.11 wireless radio used to send and receive data for display to the user).

In some embodiments, low-power wireless radio 101E may be configured to turn on for short periods of time to send beacons, and then turn itself off. Low-power wireless radio 101E may draw power from one or both of kinetic energy source 101D or backup battery 101C in order to turn itself on, transmit one or more beacons for a short period of time (e.g., 3 seconds), and turn itself off. The frequency with which low-power wireless radio 101E turns itself on and the duration during which it sends beacons may, in some embodiments, depend on the motion of mobile device 101. For example, if a user carrying mobile device 101 is running at a relatively fast pace (e.g., five minutes per mile), kinetic energy source 101D may generate enough energy to keep low-power wireless radio 101E on without it needing to draw from backup battery 101C.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner, replaced, omitted, duplicated, or supplemented by other components. Advantageous results may still be achieved if values or data were different than explicitly disclosed. Other implementations are also within the scope of the present disclosure.

The term “computer system” is intended to encompass both a single computer and multiple computers acting in tandem or cooperation with one another (e.g., parallel processing, computer clustering, or the like).

It is to be understood that both the foregoing general description and the following detailed description are exemplary and explanatory only and are not restrictive of the disclosed embodiments, as claimed. Note also that, as used herein, the indefinite articles “a” and “an” mean “one or more” in open-ended claims containing the transitional words “comprising,” “including,” and/or “having.”

The accompanying drawings, which are incorporated in and constitute a part of this specification, illustrate one or more embodiments and together with the description, serve to explain certain aspects of the disclosed embodiments.

Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for detecting the location of a mobile device, comprising:
receiving at least one packet from a detection device, each packet comprising an identifier of the detection device and a signal strength measurement associated with the mobile device;
determining a first vector based on the received at least one packet;
retrieving one or more second vectors each comprising one or more signal strength measurements;
calculating one or more differences between the first vector and the one or more second vectors; and
based on the calculated differences, determining a location of the mobile device; and
sending information related to the location of the mobile device to at least one of the mobile device or another device.

2. The method of claim 1, wherein:
the mobile device is associated with a unique identifier, and
the at least one packet comprises a second identifier associated with the mobile device and not equal to the unique identifier.

3. The method of claim 1, wherein each second vector comprises at least one signal strength measurement and at least one identifier of the detection device.

4. The method of claim 3, wherein calculating and sending further comprises:
for each second vector:
determining a first signal strength measurement based on the first vector;
determining a second signal strength measurement based on the second vector;
determining a difference between the first and second signal strength measurements; and
generating a distance associated with the second vector based on the determined difference;
determining a second vector having a lowest generated distance; and
sending a communication comprising a location associated with the second vector having the lowest distance.

5. The method of claim 4, wherein determining a difference between the first and second signal strength measurements comprises determining one of:
a difference between the first and second signal strength measurements, squared; or
a difference between 1 and a ratio of the first and second signal strength measurements, squared.

6. The method of claim 1, wherein the calculated differences comprise difference values.

7. The method of claim 4, wherein the generated distance comprises distance values.

8. A system, comprising:
a storage device comprising instructions; and
one or more electronic processors, the one or more electronic processors configured to execute the instructions to perform a method comprising:
receiving at least one packet from a detection device, each packet comprising an identifier of the detection device and a signal strength measurement associated with the mobile device;
determining a first vector based on the received at least one packet;
retrieving one or more second vectors each comprising one or more signal strength measurements;
calculating one or more differences between the first vector and the one or more second vectors; and
based on the calculated differences, determining a location of the mobile device; and
sending information related to the location of the mobile device to at least one of the mobile device or another device.

9. The system of claim 8, wherein:
the mobile device is associated with a unique identifier, and
the at least one packet comprises a second identifier associated with the mobile device and not equal to the unique identifier.

10. The system of claim 8, wherein each second vector comprises at least one signal strength measurement and at least one identifier of the detection device.

11. The system of claim 10, wherein calculating and sending further comprises:
for each second vector:
determining a first signal strength measurement based on the first vector;
determining a second signal strength measurement based on the second vector; and
determining a difference between the first and second signal strength measurements;
generating a distance associated with the second vector based on the determined difference;
determining a second vector having a lowest generated distance; and
sending a communication comprising a location associated with the second vector having the lowest distance.

12. The system of claim 11, wherein determining a difference between the first and second signal strength measurements comprises determining one of:
a difference between the first and second signal strength measurements, squared; or
a difference between 1 and a ratio of the first and second signal strength measurements, squared.

13. The system of claim 8, wherein the calculated differences comprise difference values.

14. The system of claim 11, wherein the generated distance comprises distance values.

15. A non-transitory computer-readable medium comprising instructions that, when executed by one or more processors, causes the one or more processors to perform a method comprising:
receiving at least one packet from a detection device, each packet comprising an identifier of the detection device and a signal strength measurement associated with the mobile device;
determining a first vector based on the received at least one packet;
retrieving one or more second vectors each comprising one or more signal strength measurements;
calculating one or more differences between the first vector and the one or more second vectors; and
based on the calculated differences, determining a location of the mobile device; and
sending information related to the location of the mobile device to at least one of the mobile device or another device

16. A system comprising a detection device, a server, and a mobile device;
wherein the mobile device comprises:
at least one radio configured to transmit wireless beacons for receipt by the one or more detection devices;
wherein the detection device comprises:
a storage device comprising instructions; and
one or more electronic processors, the one or more electronic processors configured to execute the instructions to perform a first method comprising:
receiving one or more beacons from the mobile device;
determining a signal strength measurement associated with each beacon; and
sending at least one packet comprising at least one beacon and a signal strength measurement to the server;
wherein the server comprises:
a storage device comprising instructions; and
one or more electronic processors, the one or more electronic processors configured to execute the instructions to perform a second method comprising:
receiving at least one packet from the detection device, each packet comprising an identifier of the detection device and a signal strength measurement associated with the mobile device;
determining a first vector based on the received at least one packet;
retrieving one or more second vectors each comprising one or more signal strength measurements;
calculating one or more differences between the first vector and the one or more second vectors; and
based on the calculated differences, determining a location of the mobile device; and
sending information related to the location of the mobile device to at least one of the mobile device or another device.

17. The system of claim 16, wherein the wireless beacons transmitted by the radio comprise an identifier associated with the mobile device.

18. The system of claim 17, wherein the mobile device is associated with a unique identifier that is not equal to the identifier in the beacons.

19. The system of claim 16, wherein the mobile device is a wearable device.

20. The system of claim 16, wherein the mobile device comprises a kinetic energy source, the kinetic energy source being coupled to the radio and configured to provide energy to the radio when the mobile device is moved.
